(19) United States
(12) Patent Application Publication
(10) Pub. No.: US 2013/0230174 A1
(43) Pub. Date: Sep. 5, 2013

(54) ELECTRONIC-ACOUSTIC DEVICE FEATURING A PLURALITY OF INPUT SIGNALS BEING APPLIED IN VARIOUS COMBINATIONS TO A LOUDSPEAKER ARRAY

(71) Applicant: RENE-MARTIN OLIVERAS, Florham Park, NJ (US)

(72) Inventor: RENE-MARTIN OLIVERAS, Florham Park, NJ (US)

(21) Appl. No.: 13/411,540

(22) Filed: Mar. 3, 2012

(51) Int. Cl. H04R 5/00

(52) U.S. Cl. 381/17

(57) ABSTRACT

According to one embodiment of the present invention, an electronic-acoustic device which is responsive to at least one input signal comprises: a spatial orientation sensor for detecting the vertical direction; a sound channel distributor/director for providing a plurality of output signals, and which is jointly responsive to such at least one input signal and to the spatial orientation sensor; a multi-channel amplifier which is responsive to a the plurality of output signals of the sound channel distributor/director; and a loudspeaker array which is responsive to the multi-channel amplifier for producing different sets of output sounds in the various spatial orientations of the device.

### BACKGROUND OF THE INVENTION

This patent application is a continuation-in-part of co-pending patent application serial number 653,668, filed on Dec. 17, 2009, and entitled SYSTEM AND METHOD FOR APPLYING A PLURALITY OF INPUT SIGNALS TO A LOUDSPEAKER ARRAY by the same inventor herein.

1. Field of the Invention

This invention relates to an ELECTRONIC-ACOUSTIC DEVICE FEATURING A PLURALITY OF INPUT SIGNALS BEING APPLIED IN VARIOUS COMBINATIONS TO A LOUDSPEAKER ARRAY for producing different sets of output sounds in various spatial orientations of the device.

2. Description of the Prior Art

The prior art discloses the following:

An inclinometer is an instrument for measuring angles of slope (or tilt), elevation or depression of an object with respect to gravity. It is also known as a tilt meter, tilt indicator, slope alert, slope gauge, gradient meter, gradiometer, level gauge, level meter, declinometer, and pitch & roll indicator. Clinometers measure both inclines (positive slopes, as seen by an observer looking upwards) and declines (negative slopes, as seen by an observer looking downward). (SEE WIKIPEDIA ARTICLE OF “INCLINOMETERS”)

Slayton et al patent application publication 2002-0087080 published on Jul. 4, 2002 and entitled Visual imaging system for ultrasonic probe states as follows: “While an exemplary embodiment of a positioning indicator can comprise a series of marks 308, such as two, three, four or more, or a single mark, positioning indicator 308 can comprise any mechanism for facilitating the determination of the geometry of transducer 102 with respect to the patient. Thus, the positioning indicator can also comprise any three-dimensional positioning indicator devices that can provide information regarding the position of transducer 102 with respect to the patient. For example, the positioning indicator can comprise an electromagnetic device configured within transducer 102 that can be suitably tracked by electromagnetic sensors configured with control system 100. In addition, the positioning indicator can comprise a gravitational accelerometer configured to provide the assessment of three axis or rotation of transducer 102 in three dimensions. Such a collection of three-dimensional information could also be suitably correlated with three-dimensional imaging information, as disclosed more fully in U.S. patent application Ser. No. 09/502,174, entitled IMAGING, THERAPY AND TEMPERATURE MONITORING ULTRASONIC SYSTEM, hereby incorporated herein by reference.”

Weinbrenner U.S. Pat. No. 6,466,887 issued on Oct. 12, 2002 and entitled Gravimetric rotation sensors: dead reckoning, velocity, and heading sensor system for vehicle navigation systems states as follows: “A rotational sensor for use with an in-vehicle navigation system, a navigation system that uses the sensor, and a vehicle with the sensor installed. The rotational sensor is created by placing two gravitational accelerometers configured at 90 degrees with respect to one another and mounted at the center of a vehicle wheel. As this resulting sensor is rotated, sine and cosine signals with a quadrature relationship are generated with respect to the earth's gravity vector, from which both rotation and direction of rotation can be determined. These signals may then allow the counting of the turns of the wheel, thus estimating the distance and the rate at which the vehicle has moved. A self-contained version of this device including a transmitter can relay this information to a receiving unit located within the vehicle. When one of these devices is located on each of the steerable wheels of the vehicle, the relative heading-direction of the vehicle may also be estimated.” . . . “A gravimetric rotational wheel sensor for use on a mobile vehicle, the mobile vehicle having a body, and front axle engaged to the body, and at least one wheel engaged to the axle, comprising: a first accelerometer for engagement to the wheel; a second accelerometer for engagement to the wheel and aligned relatively to sense gravitational force 90 degrees out of synch from said first accelerometer; a transmitter for engagement to the wheel and for receiving electrical accelerometer output signals representing wheel rotation from said first and said second accelerometers and said transmitter for transmitting said accelerometer output signals; said first accelerometer and said second accelerometer are within a container and said container may be mounted to the wheel; a transmitter for allowing remote reporting of wheel position from said first and second accelerometers without the need for hard wiring; a microprocessor-based electronic circuit for signal processing and data correlation; said container configured to ensure said first accelerometer and said second accelerometer are located near the center of the wheel when said container is engaged to the wheel; and said microprocessor-based electronic circuit for signal processing and data correlation has a generator that may convert sensed rotational motion of the wheels to electric power.” . . . “A gravimetric rotational wheel sensor for use on a mobile vehicle, the mobile vehicle having a body, and front axle engaged to the body, and at least one wheel engaged to the axle, comprising: a first accelerometer for engagement to the wheel; a second accelerometer for engagement to the wheel and aligned relatively to sense gravitational force 90 degrees out of synch from said first accelerometer; a transmitter for engagement to the wheel and for receiving electrical accelerometer output signals representing wheel rotation from said first and said second accelerometers and said transmitter for transmitting said accelerometer output signals; said first accelerometer and said second accelerometer are within a container and said container may be mounted to the wheel; a transmitter for allowing remote reporting of wheel position from said first and second accelerometers without the need for hard wiring; a microprocessor-based electronic circuit for signal processing and data correlation; said container configured to ensure said first accelerometer and said second accelerometer are located near the center of the wheel when said container is engaged to the wheel; said first and second accelerometer provide two output wave results in a quadrature waveform in a 90 degree phase relationship between said two outputs when installed on a wheel and the wheel rotates; and said microprocessor-based electronic circuit for signal processing and data correlation has a centripetal bias signal processing circuit portion programmed for accounting for offset from center of the wheel upon mounting.” . . . “A mobile vehicle, comprising: a body; front axle engaged to said body; said front axle engaged to a left front steerable wheel and a right front steerable wheel, each of said wheels having an inner hub for mounting to said front axle; a navigation system within said body; a first gravimetric rotational wheel sensor engaged to a first of said front wheels, comprising: a first accelerometer; a second accelerometer aligned relatively to sense gravitational force 90 degrees out of synch from said first accelerometer; and a transmitter for receiving electrical accelerometer output signals representing wheel rotation from said first and said second accelerometers and said transmitter for transmitting said accelerometer output signals; a receiver and microprocessor system for receiving and error checking said electrical accelerometer output signals from said first front wheel transmitter; said receiver engaged to said navigation system to provide said electrical accelerometer output signals to said navigation system providing said navigation system an indication of distance traveled and direction of first front wheel rotation; a second gravimetric rotational wheel sensor engaged to a second of said front wheels, comprising: a third accelerometer; a fourth accelerometer aligned relatively to sense gravitational force 90 degrees out of synch from said third accelerometer; and a second transmitter for receiving electrical accelerometer output signals representing wheel rotation from said third and said fourth accelerometers and said second transmitter for transmitting said accelerometer output signals to said receiver; and said receiver, microprocessor, and navigation system programmed to process output signals from said first and second rotational wheel sensors to determine distance traveled and changes in vehicle direction due to sensed relative wheel rotation.” . . . “A gravimetric rotational wheel sensor for use on a mobile vehicle, the mobile vehicle having a body, and front axle engaged to the body, and at least one wheel engaged to the axle, comprising: an accelerometer for engagement to the wheel; and a transmitter for engagement to the wheel and for receiving electrical accelerometer output signals representing both static and dynamic wheel position and rotation from said accelerometer and said transmitter for transmitting said accelerometer output signal.” . . . “A gravimetric rotational wheel sensor for use on a mobile vehicle, the mobile vehicle having a body, and front axle engaged to the body, and at least one wheel engaged to the axle, comprising: a first accelerometer for engagement to the wheel; a second accelerometer for engagement to the wheel and aligned relatively to sense gravitational force 90 degrees out of synch from said first accelerometer; and a transmitter for engagement to the wheel and for receiving electrical accelerometer output signals representing wheel radial position in both static and dynamic conditions and amount of rotation upon rotation from said first and said second accelerometers and said transmitter for transmitting said accelerometer output signals.”

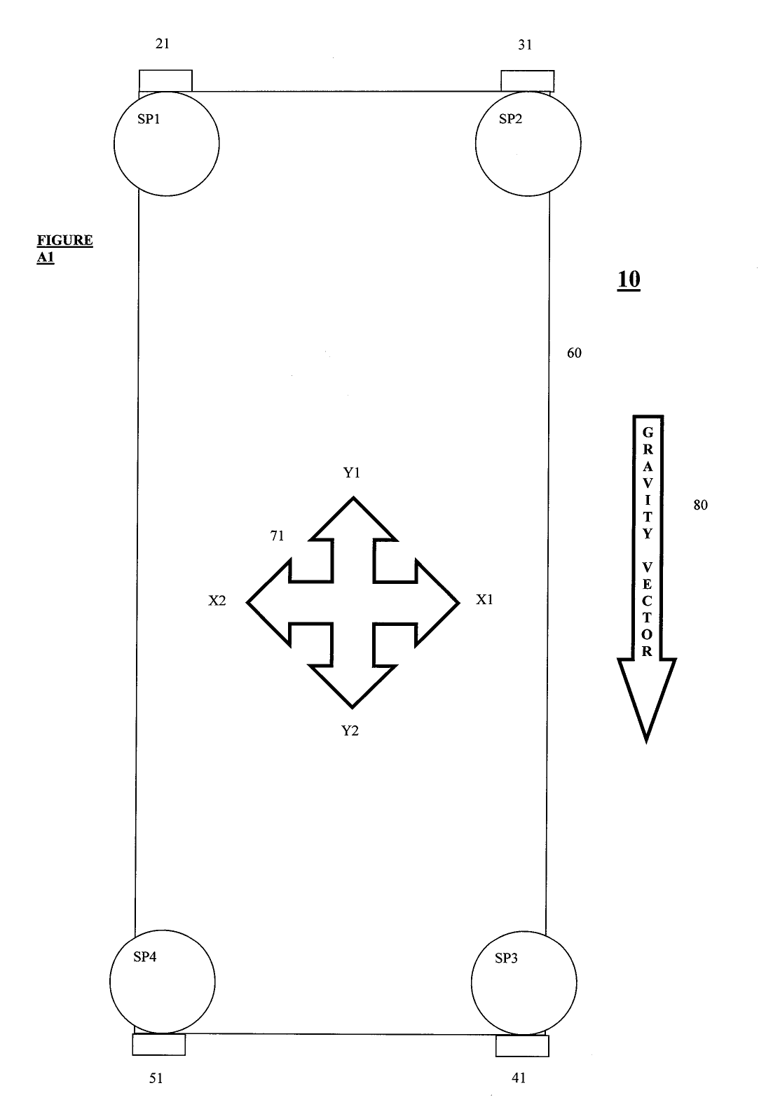

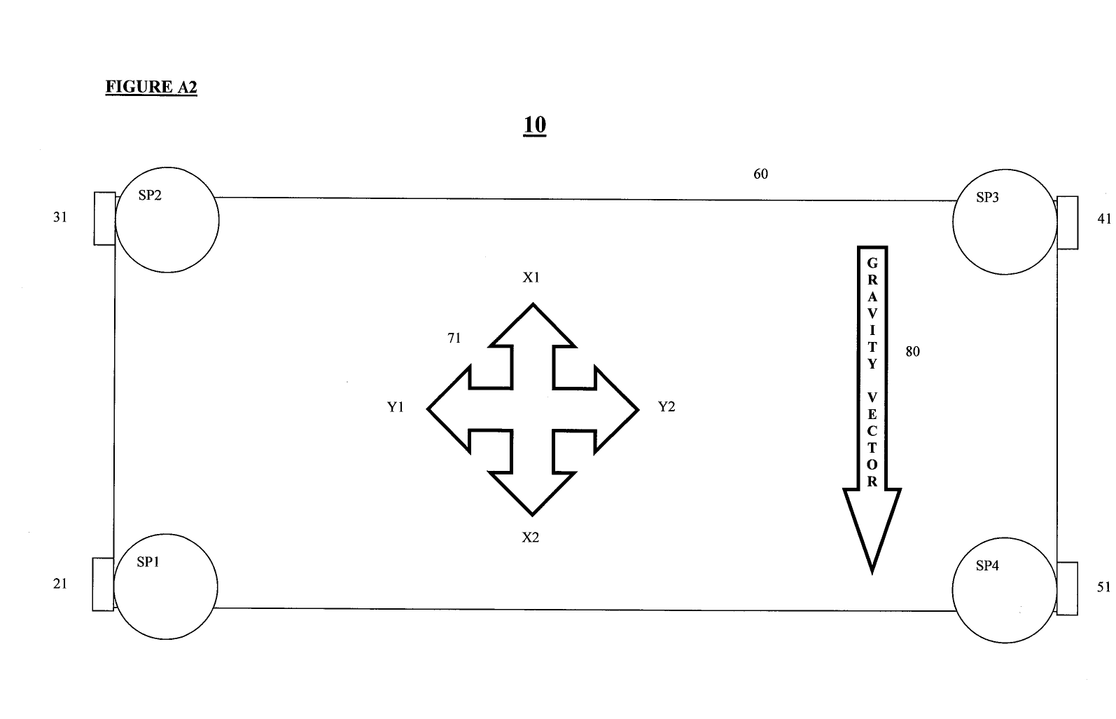

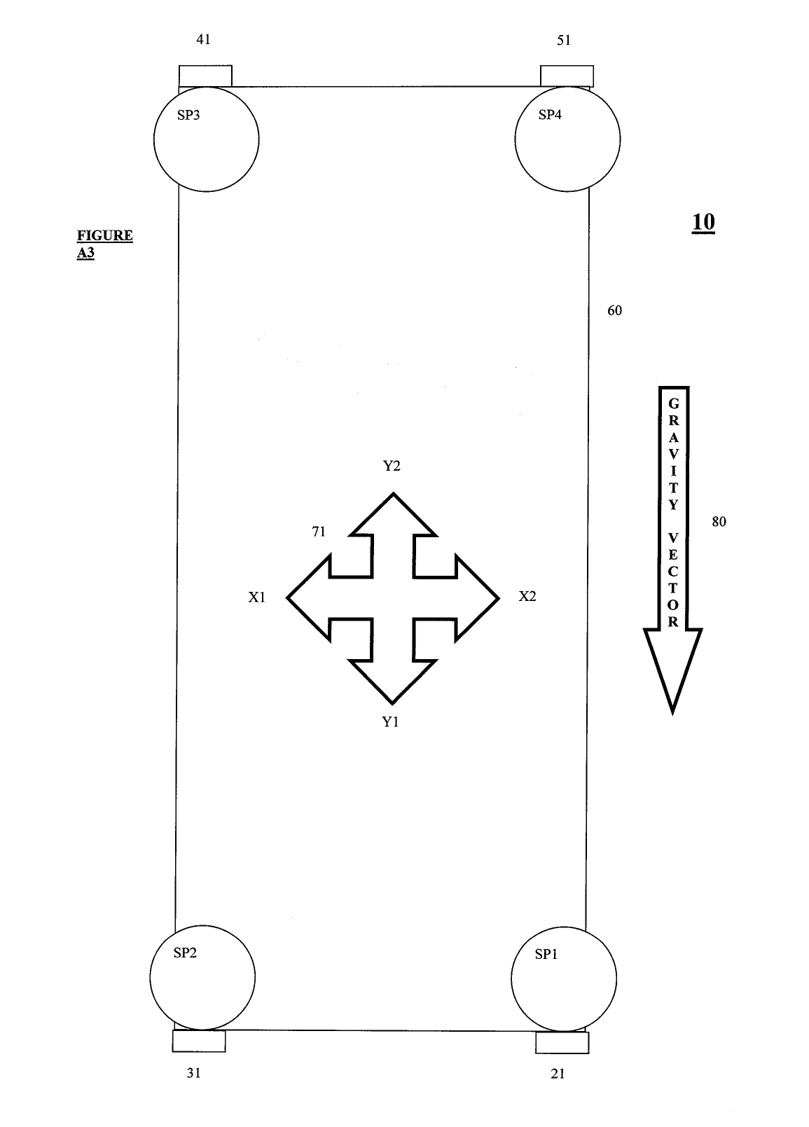

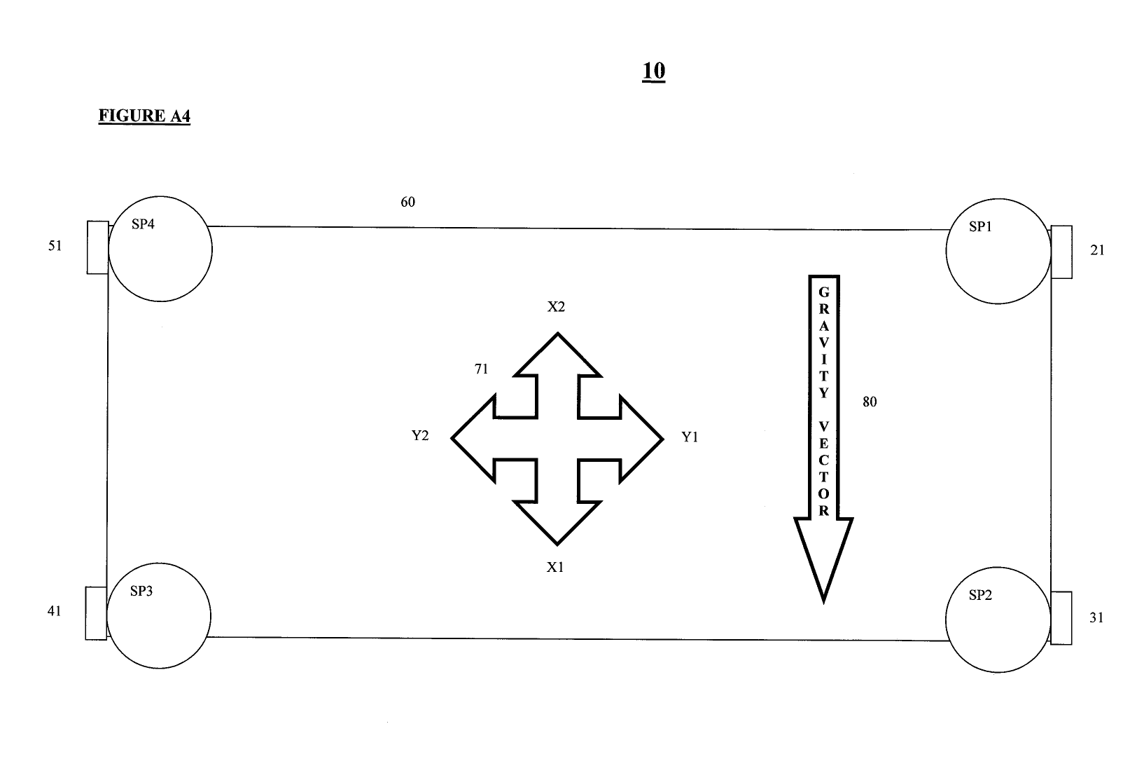

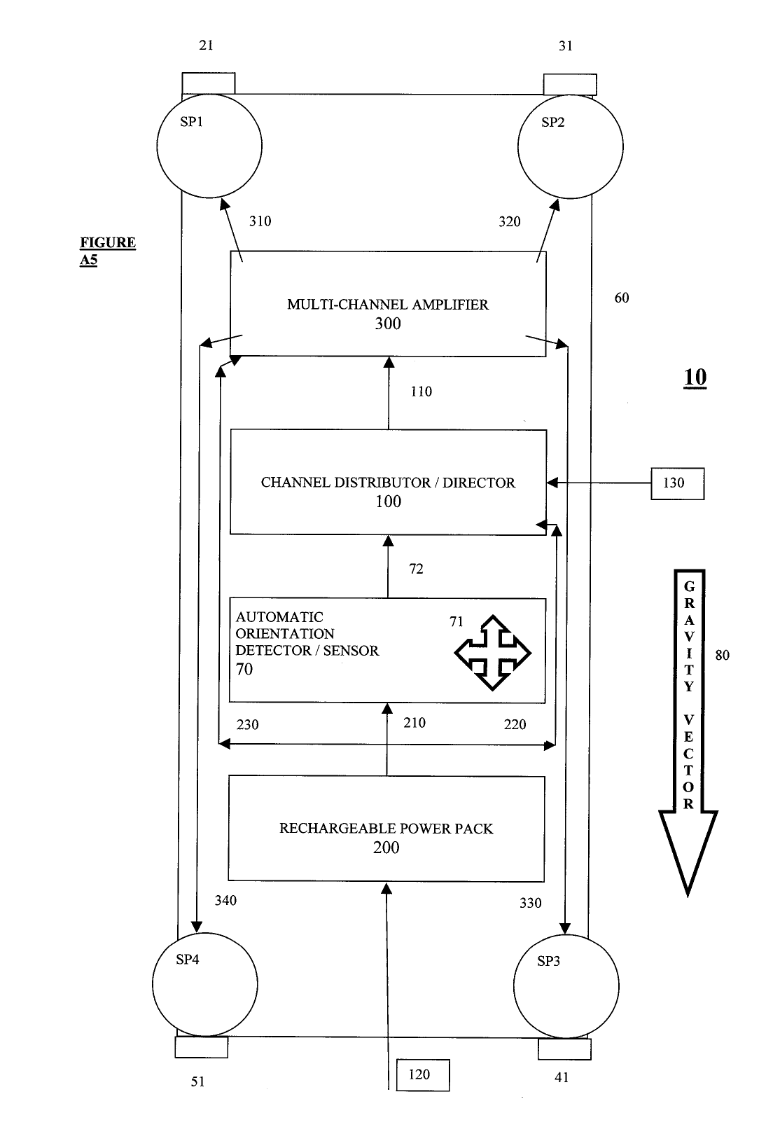

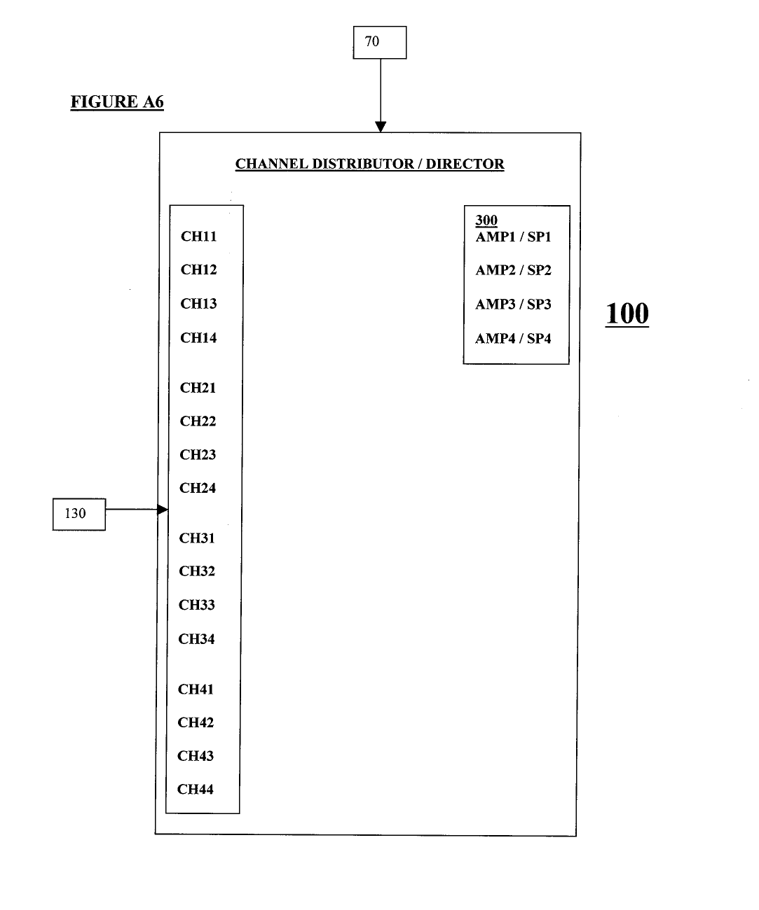

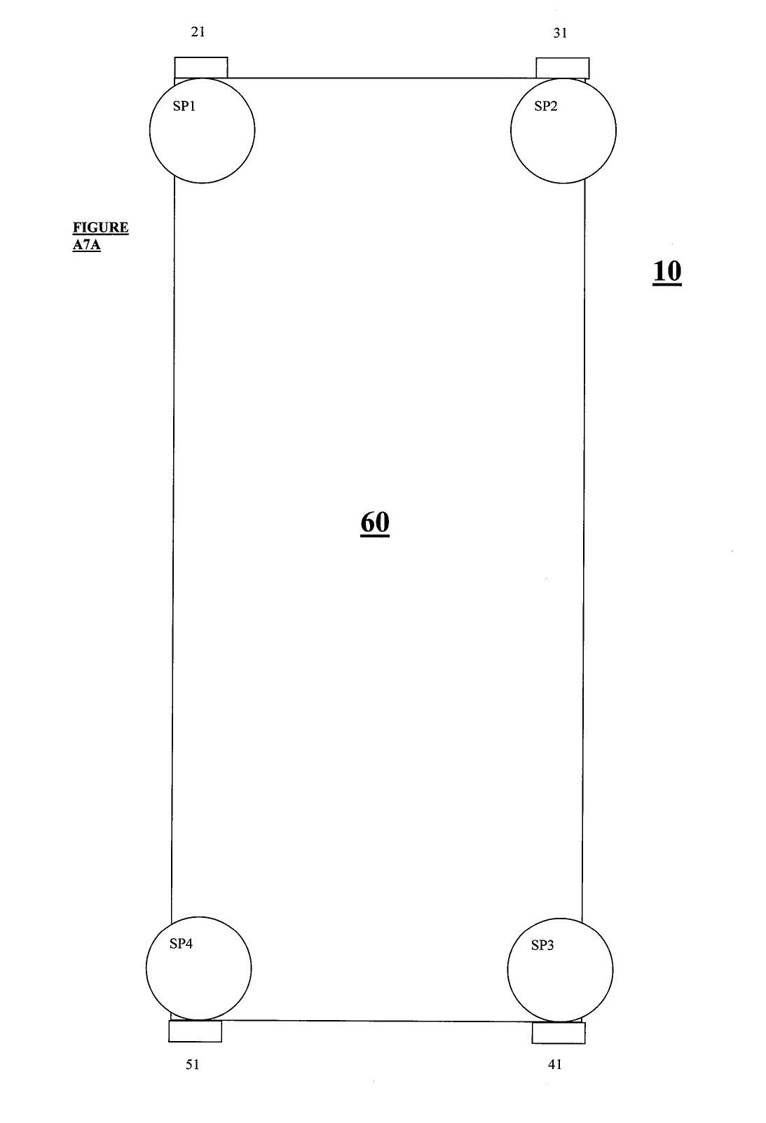

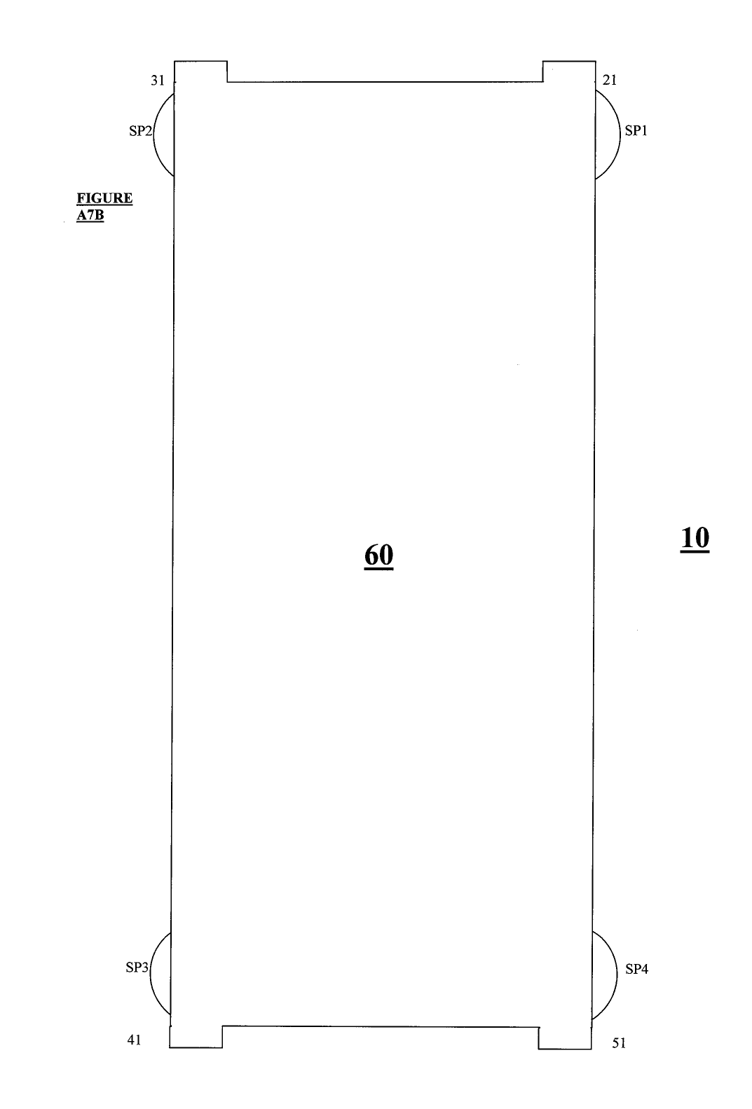

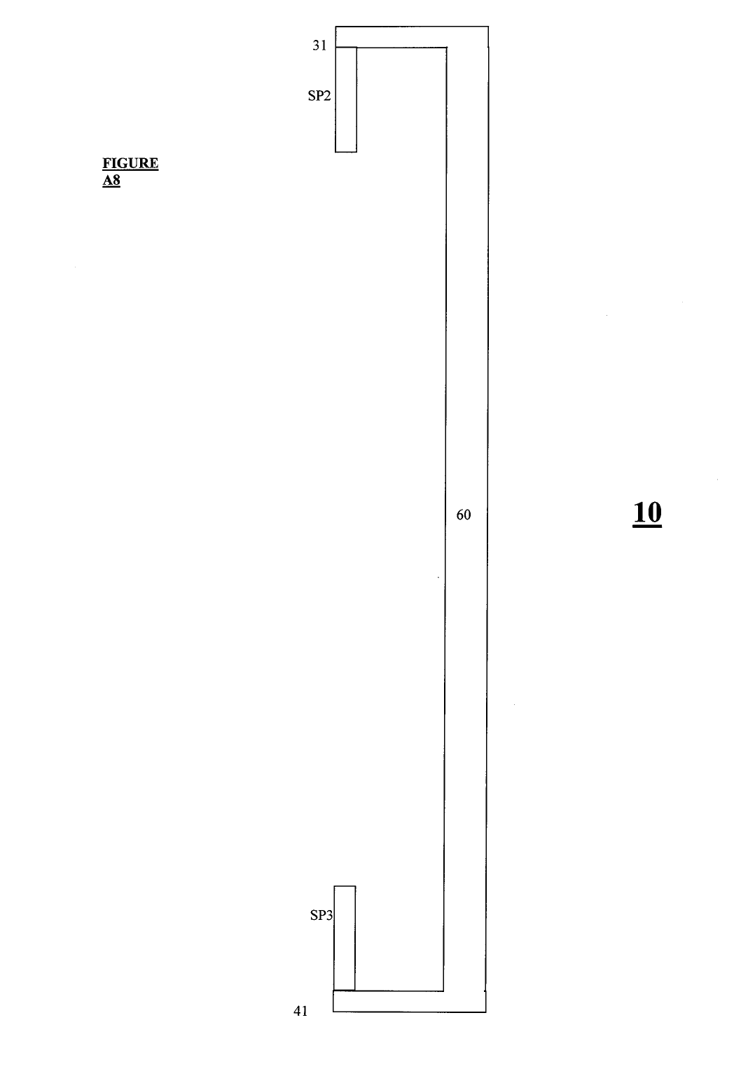

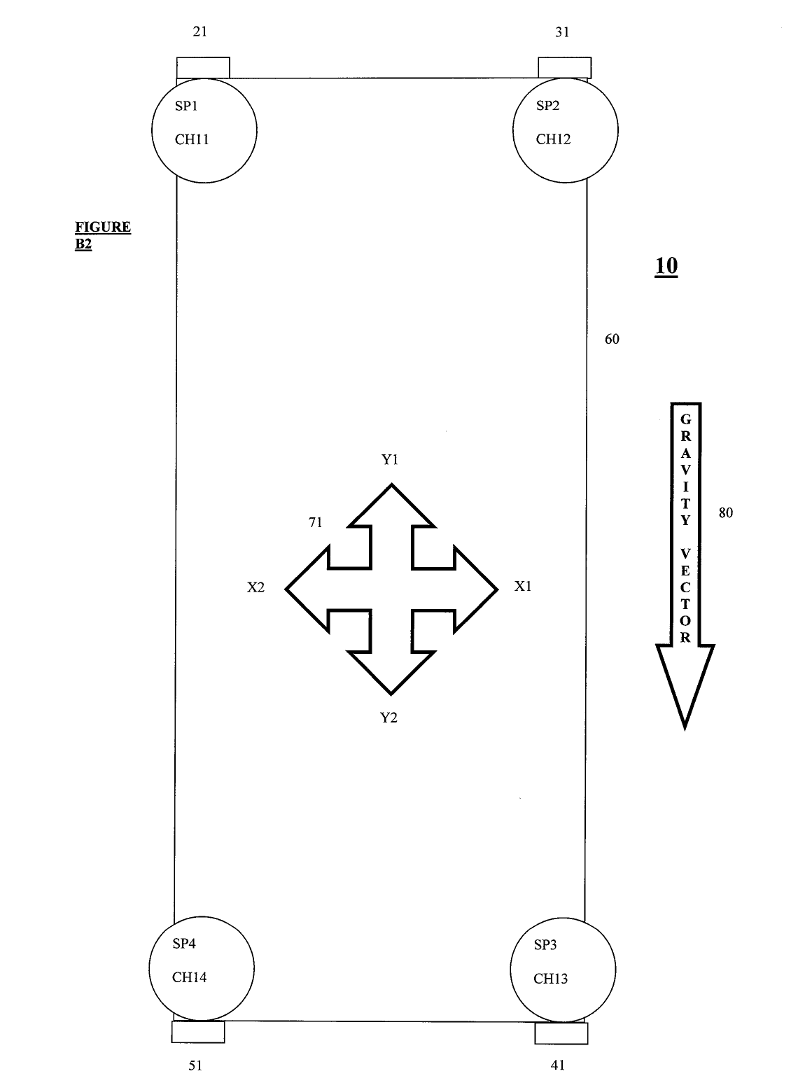

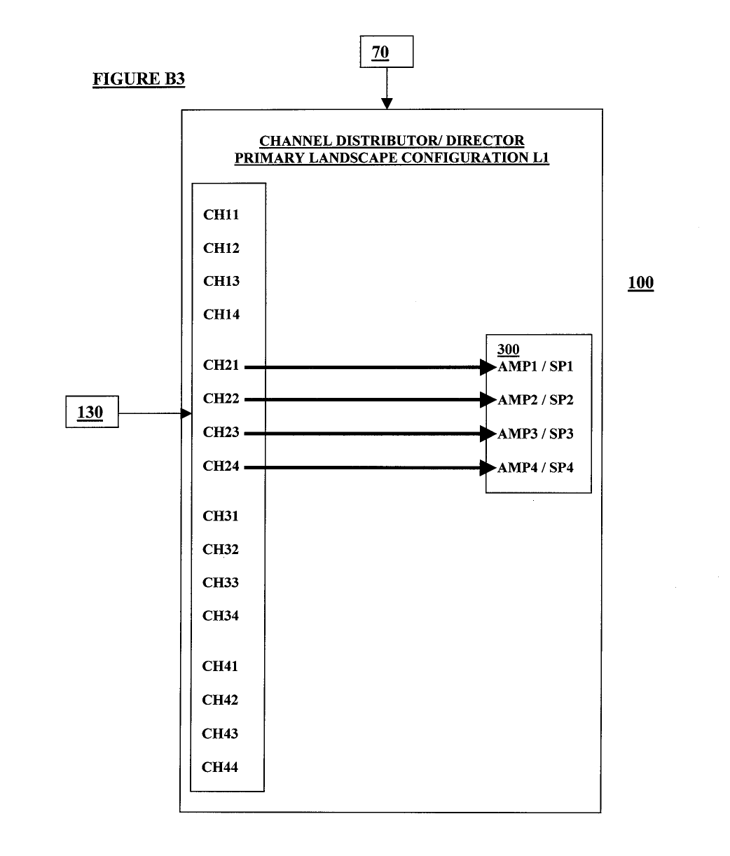

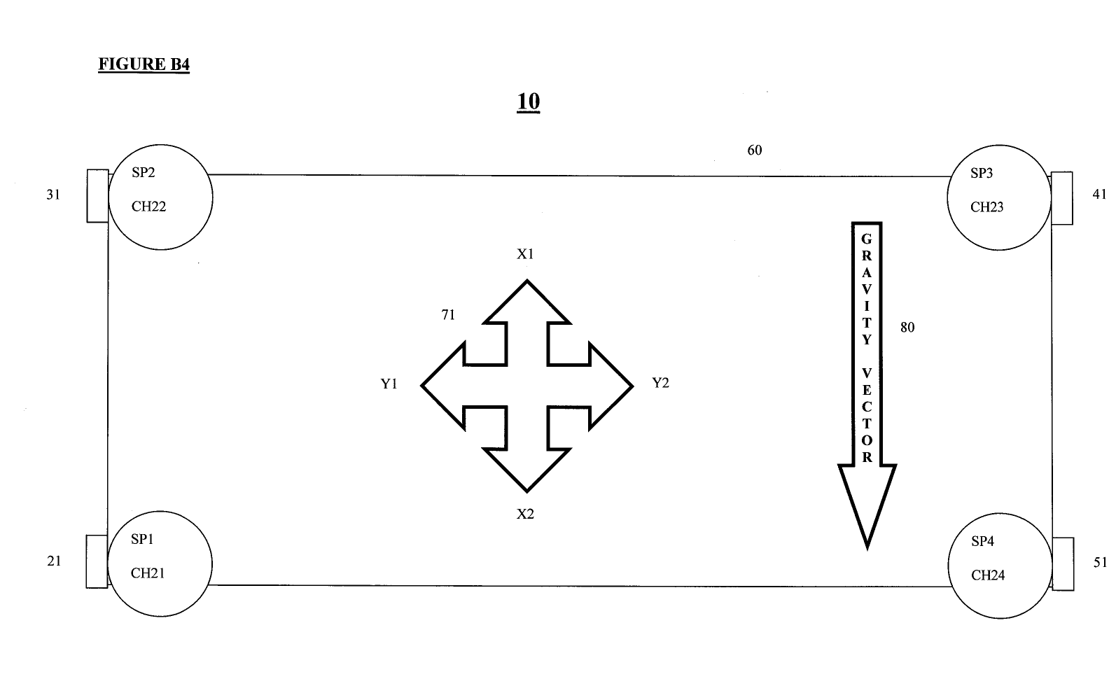

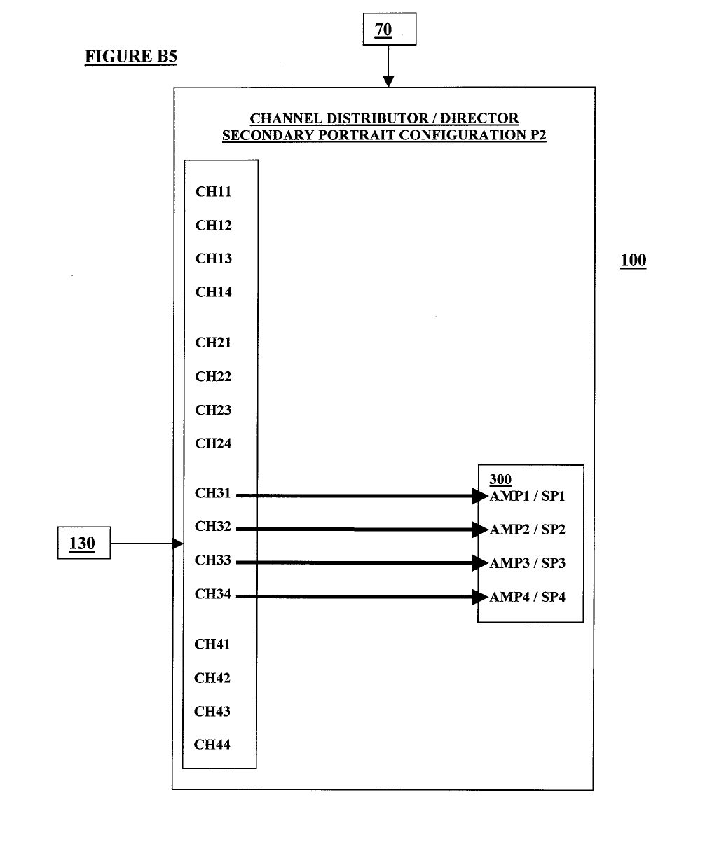

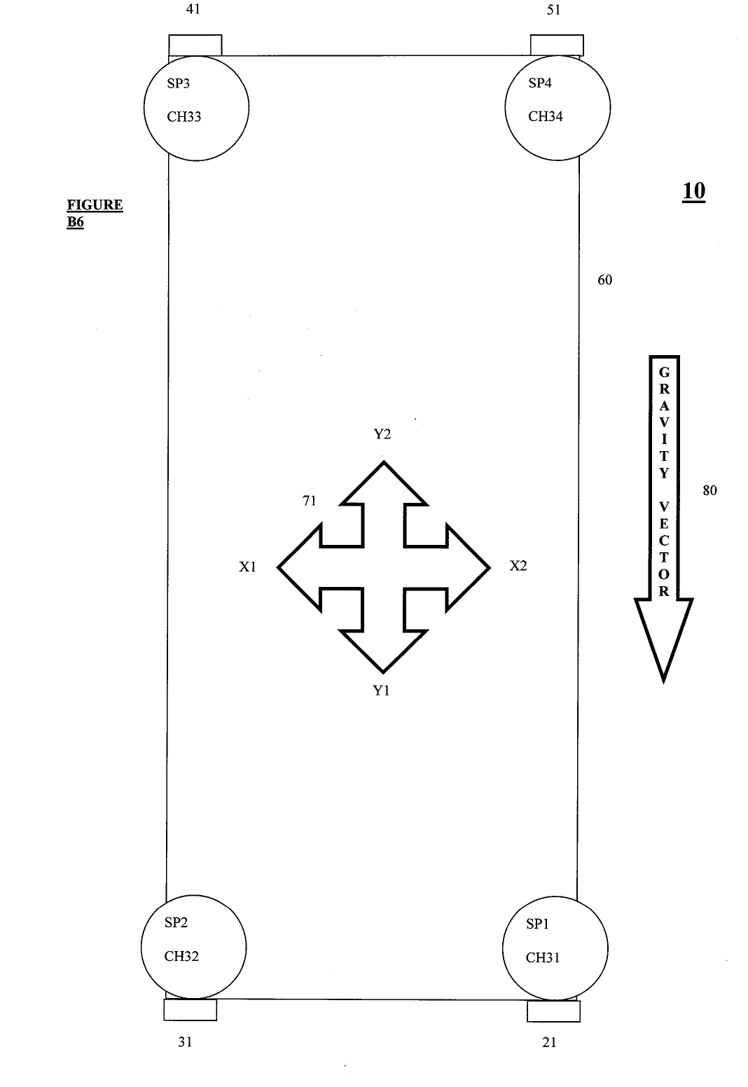

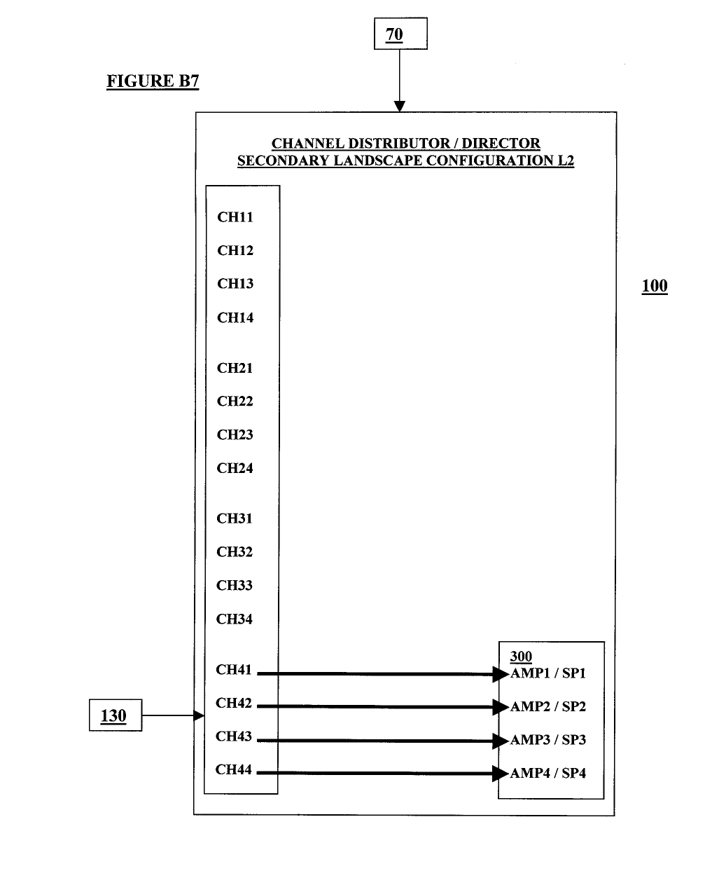

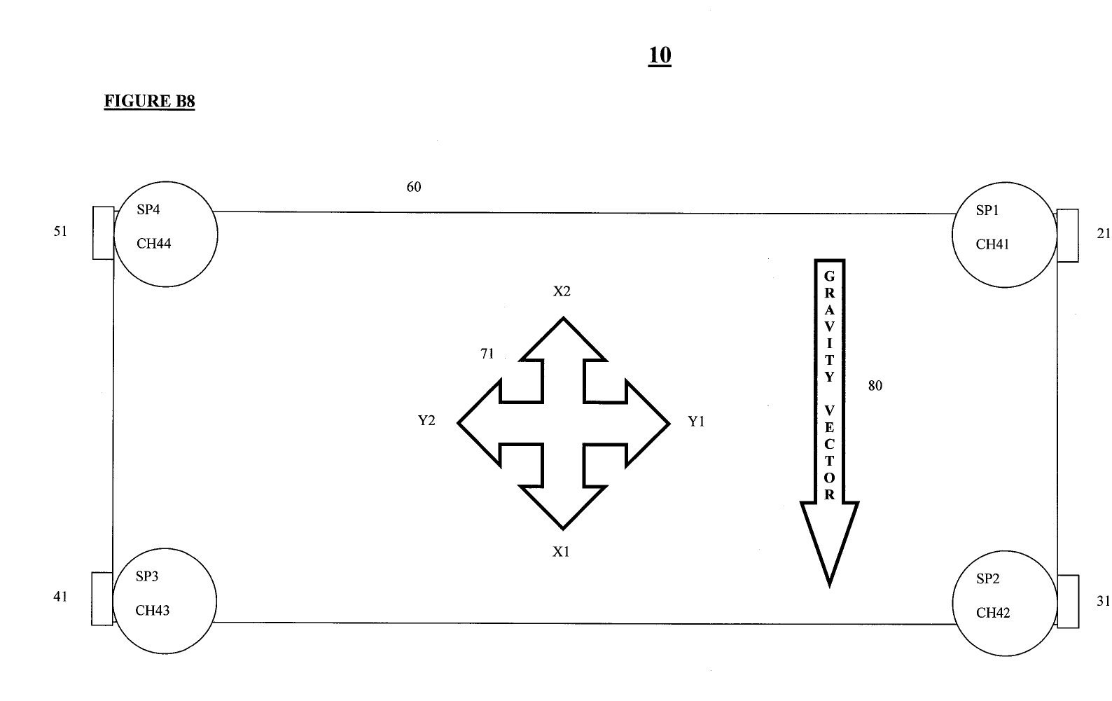

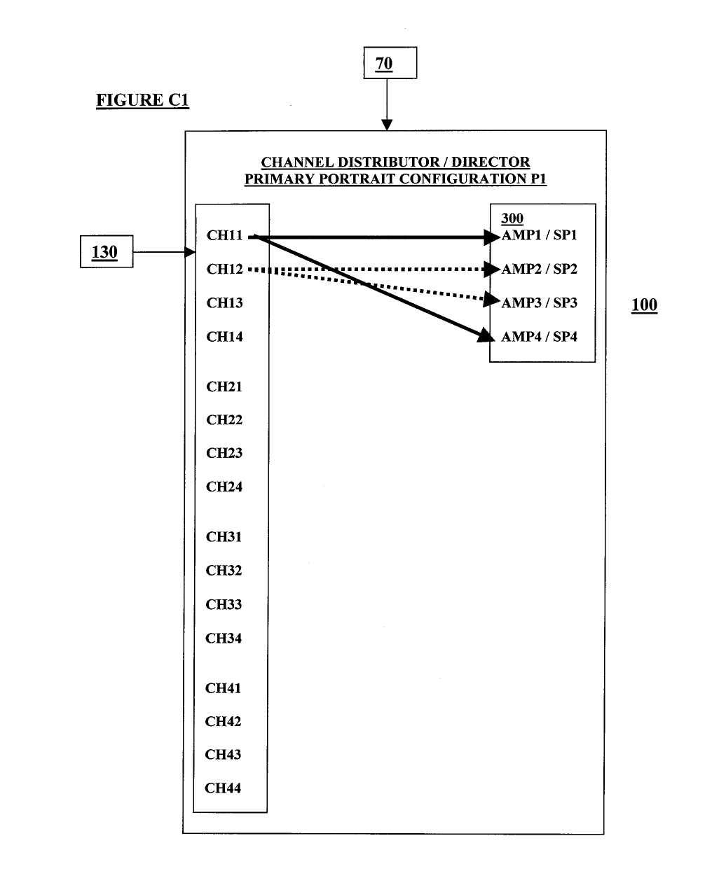

Perez patent application publication 2003-0038778 published on Feb. 27, 2003 and entitled Tilt based pointing for hand-held devices states as follows: “Referring to FIG. 1, in one embodiment, a hand-held device 10 includes a display screen 12 that is configured to display a graphical user interface, which may present one or more user commands or options for controlling the operation of hand-held device 10. A pointer 14 may be positioned over the options that are presented by the graphical user interface at any one of a plurality of pointer screen locations. A selection button 16 may be depressed to activate a command or option selected by pointer 14. Hand-held device 10 also includes an orientation (or tilt) sensor (e.g., a gravitational accelerometer) that is operable to provide an indication of the orientation of hand-held device 10, and a controller that is configured to compute pointer screen locations where pointer 14 is to be displayed based upon device orientation indications provided by the orientation sensor over time (see FIG. 5).”

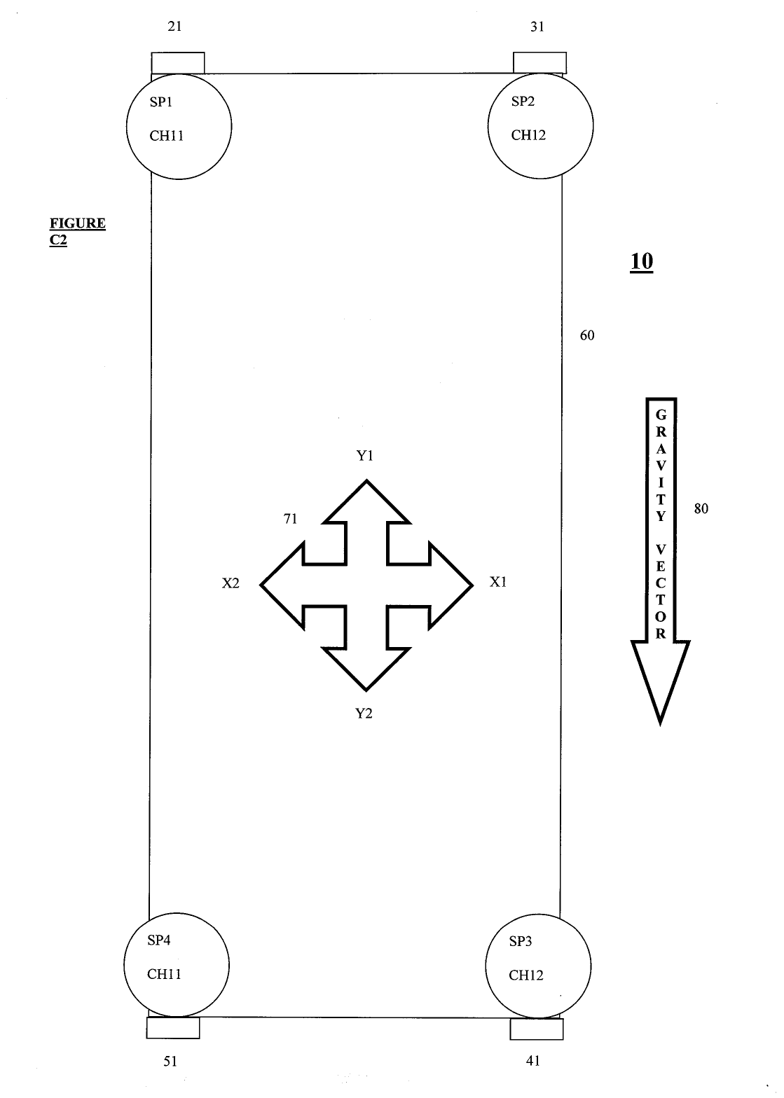

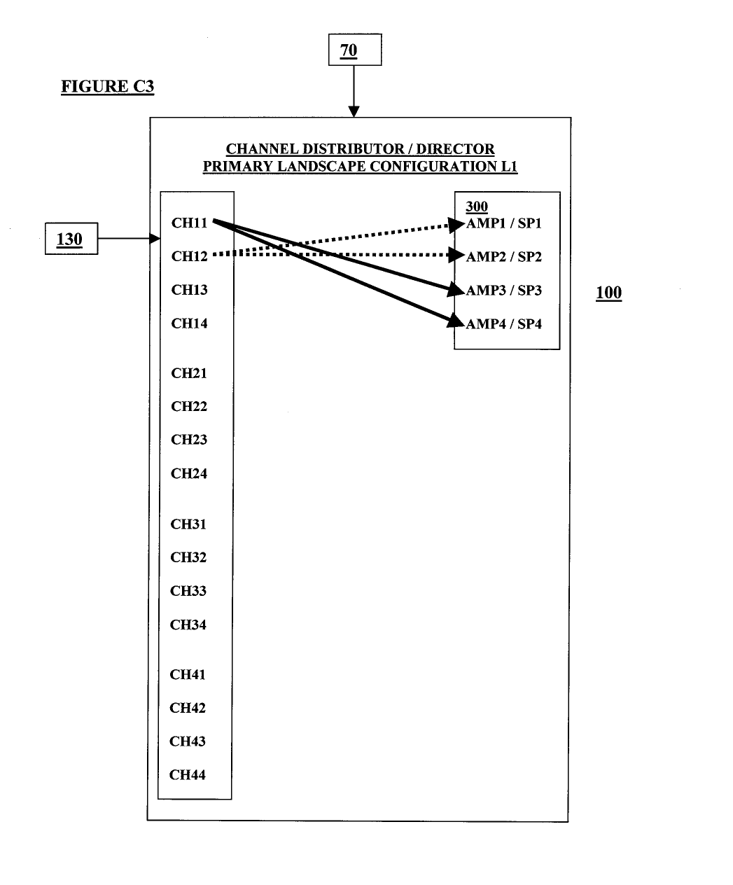

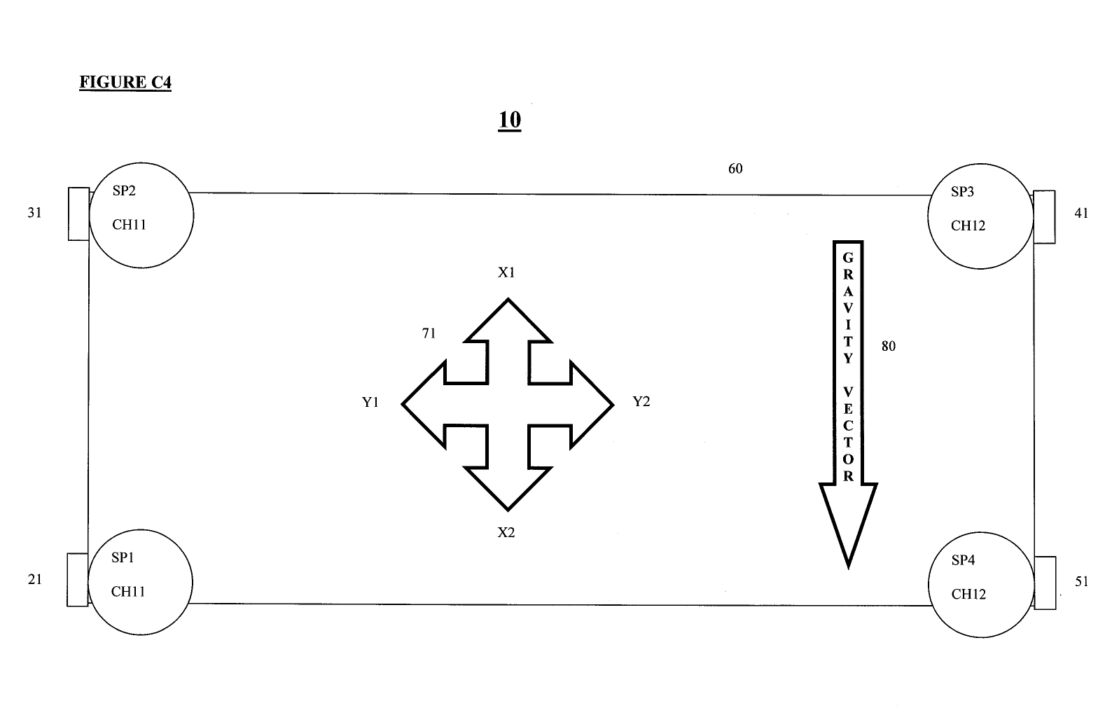

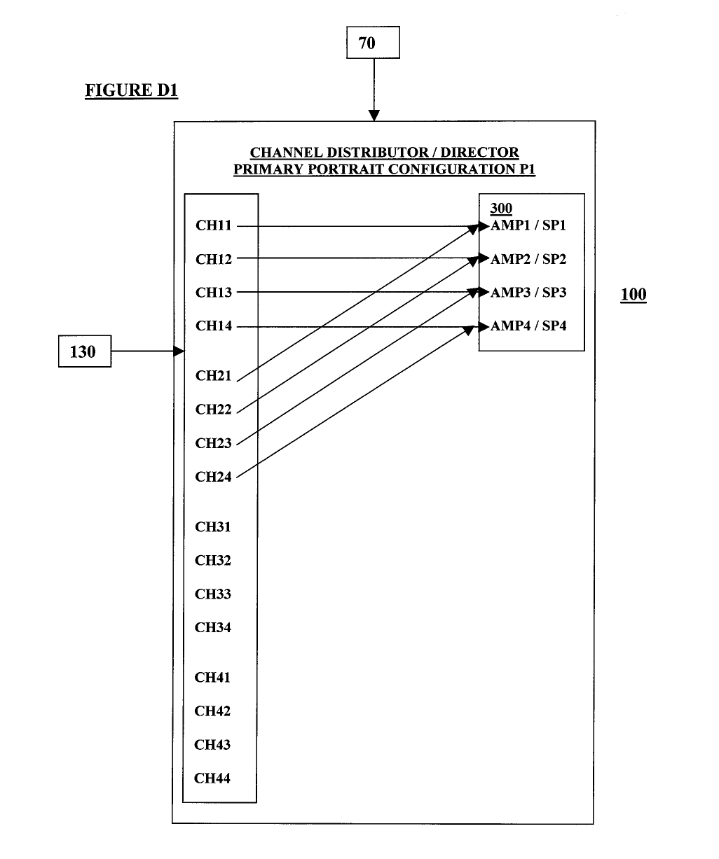

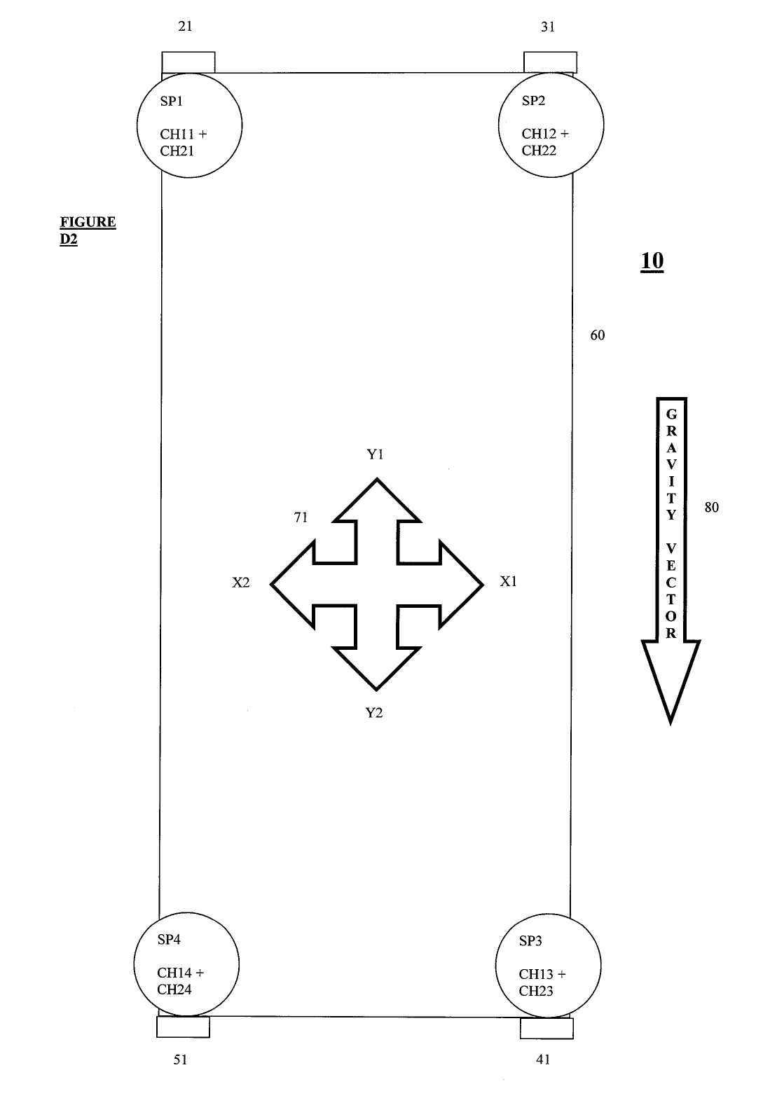

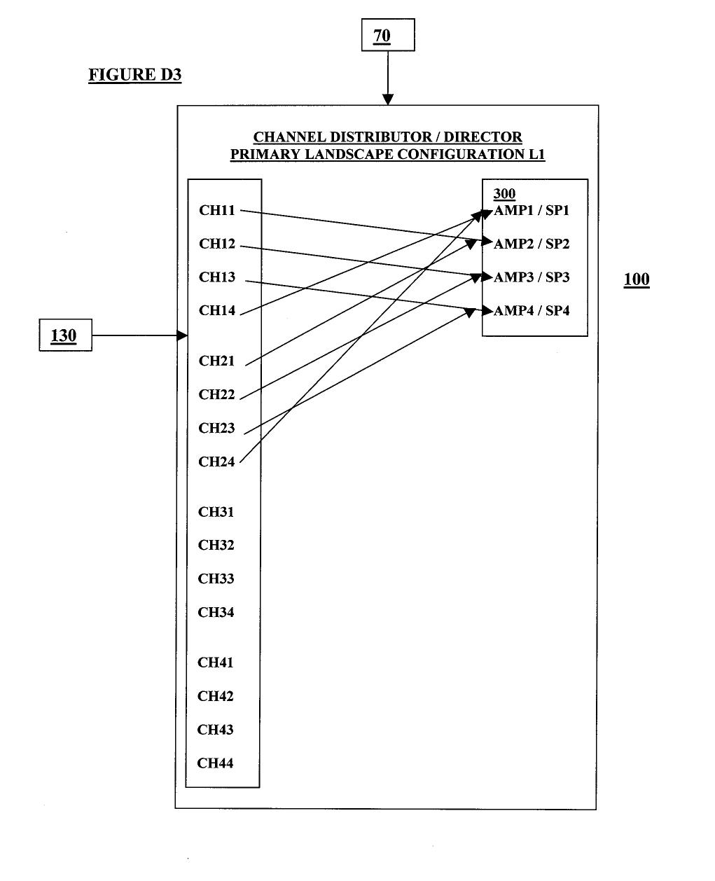

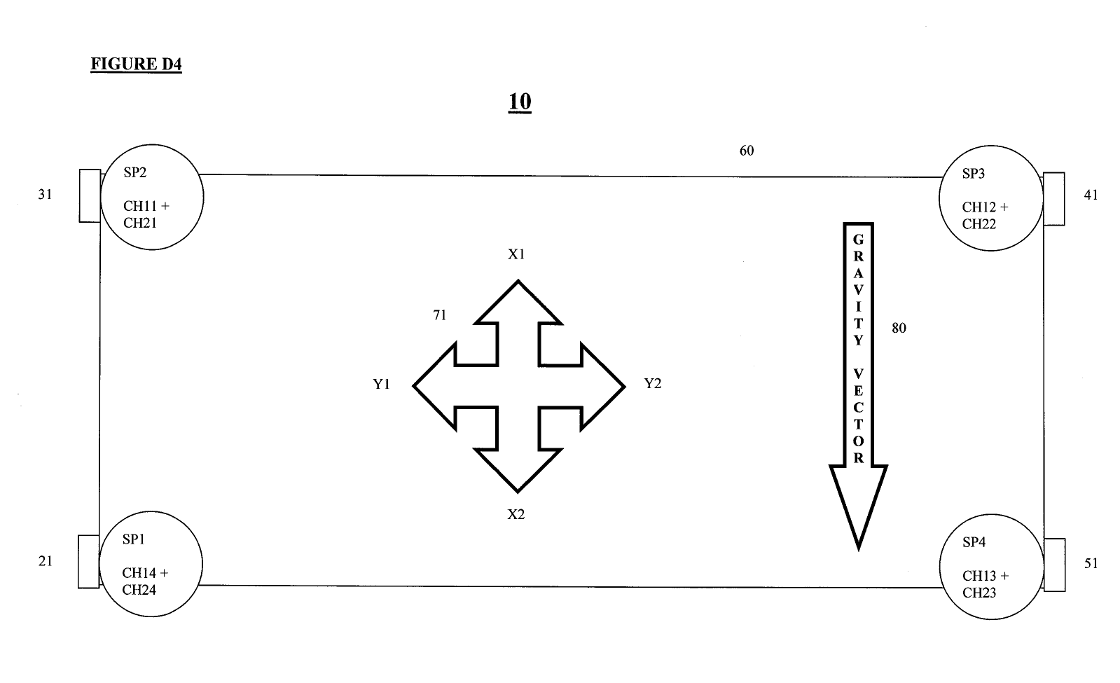

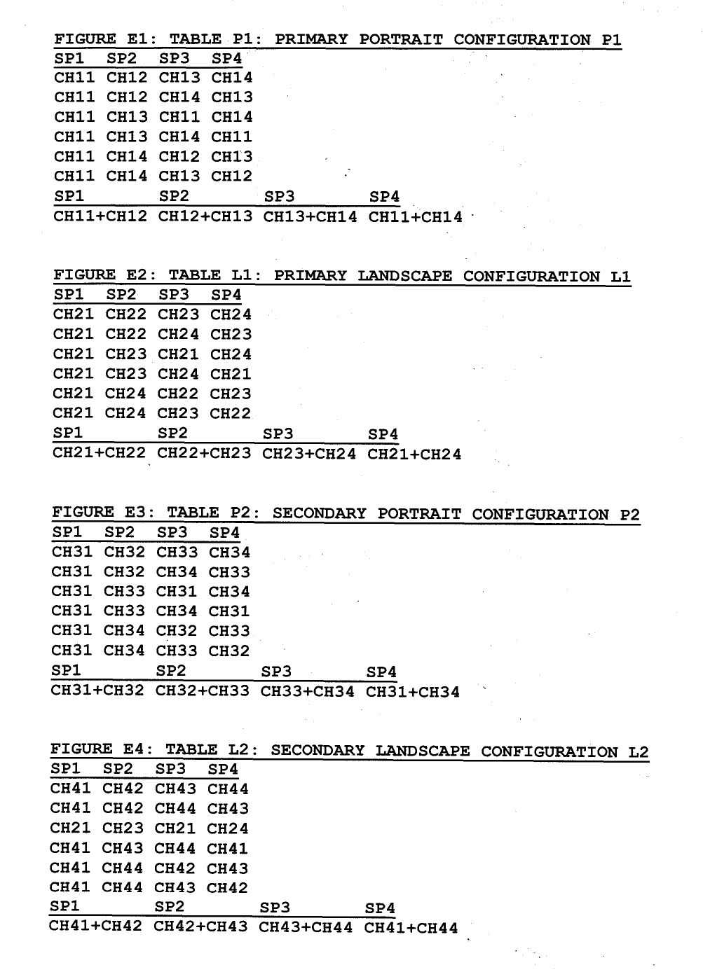

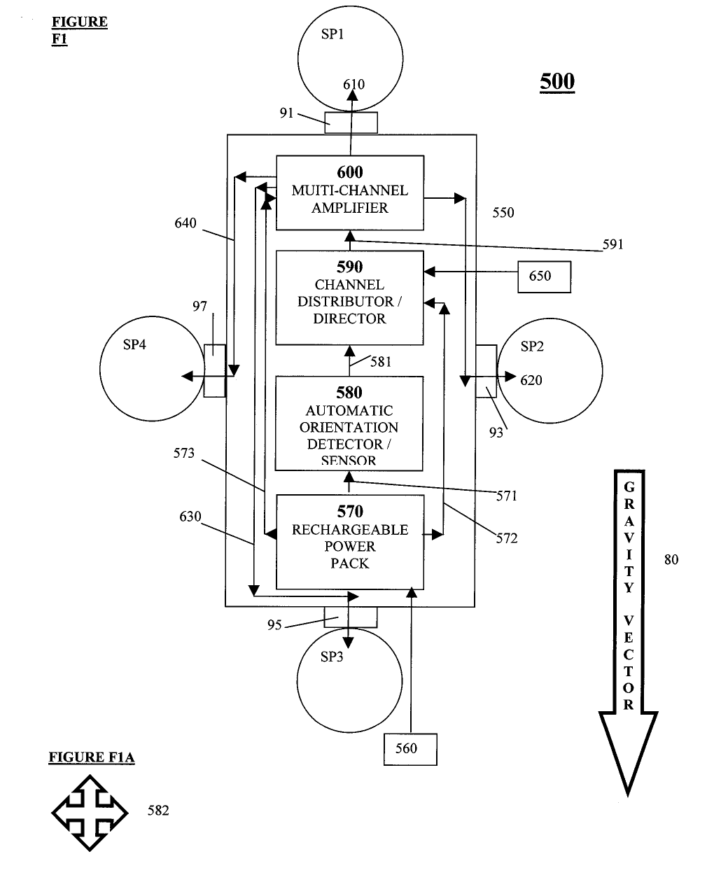

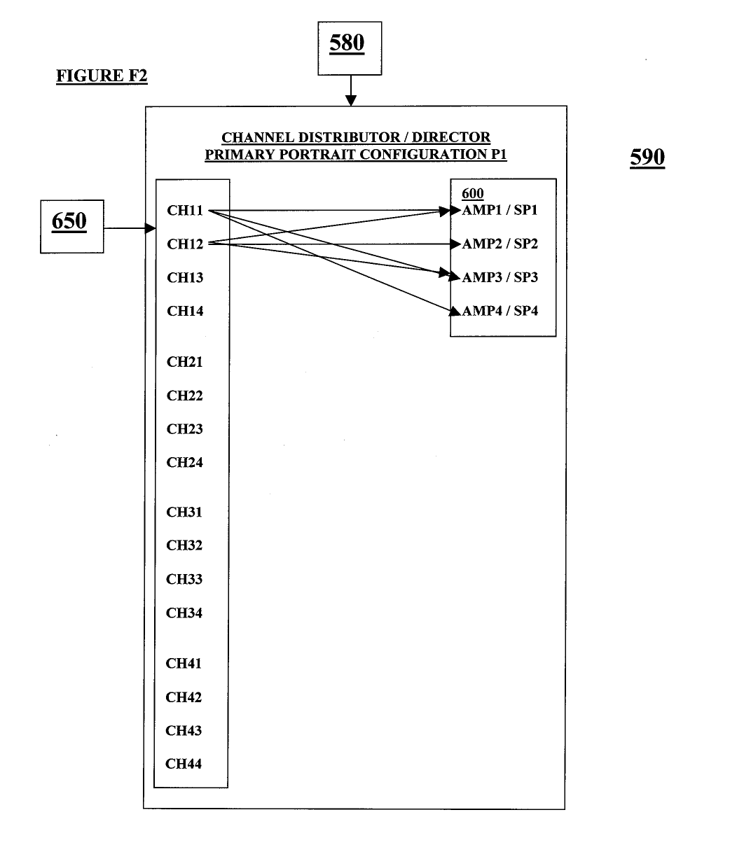

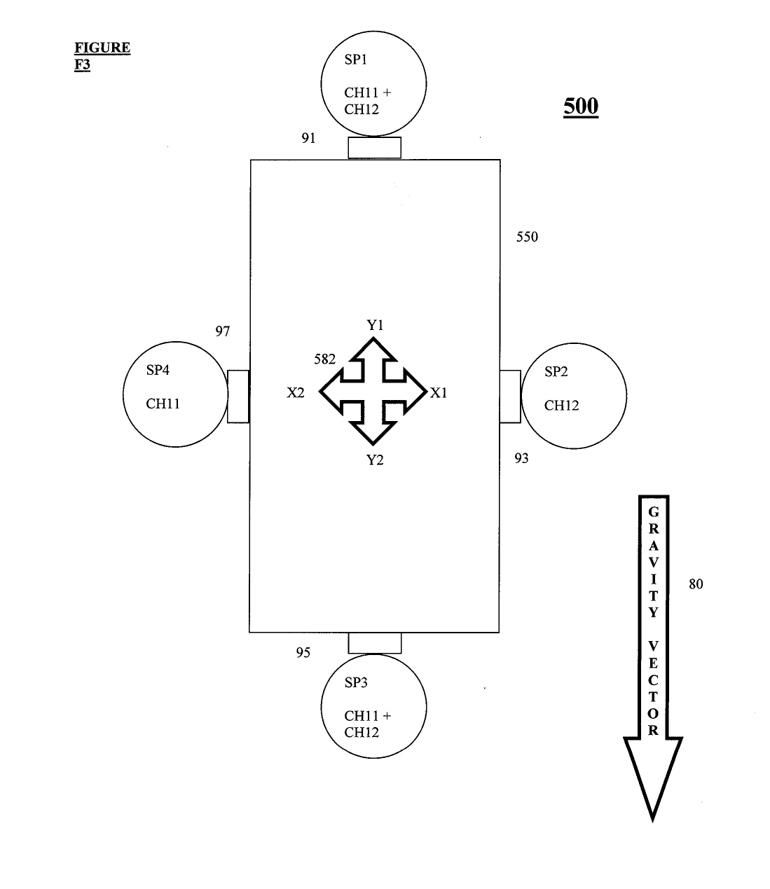

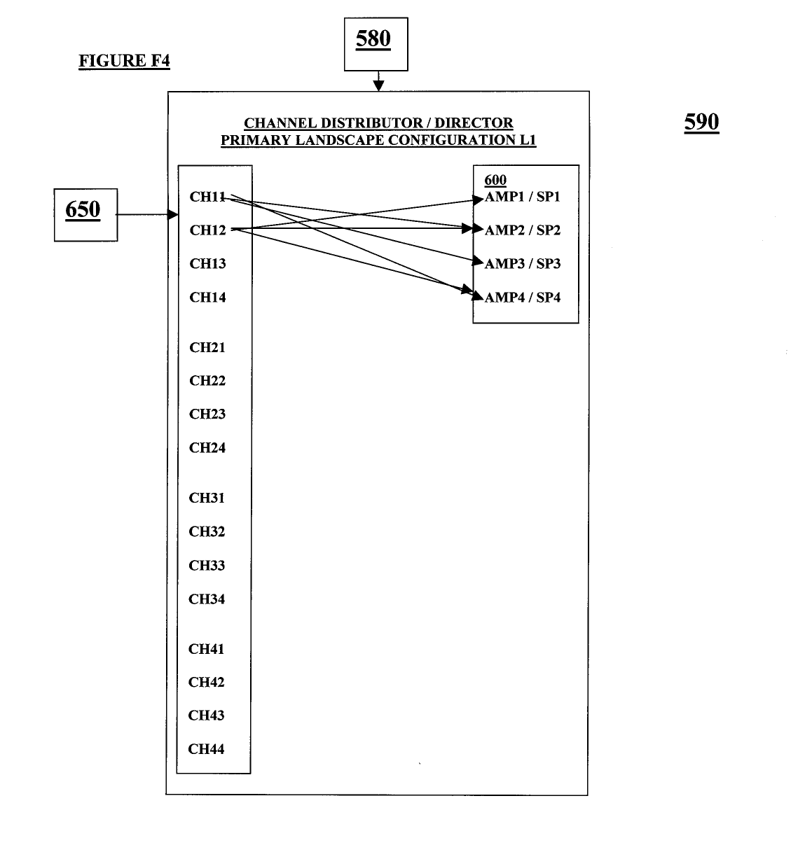

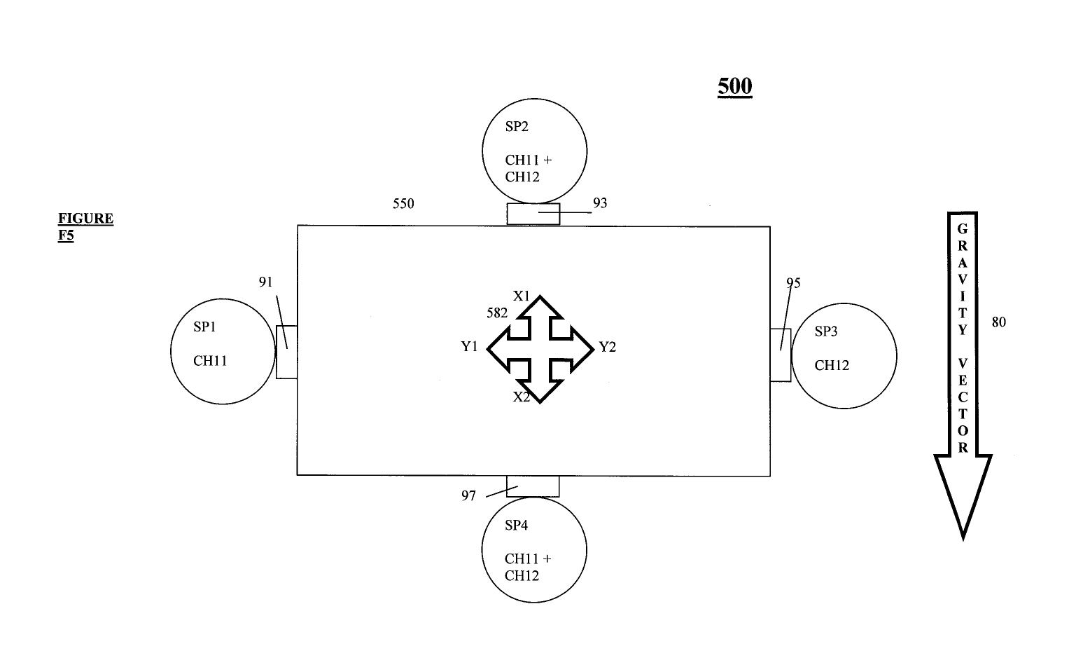

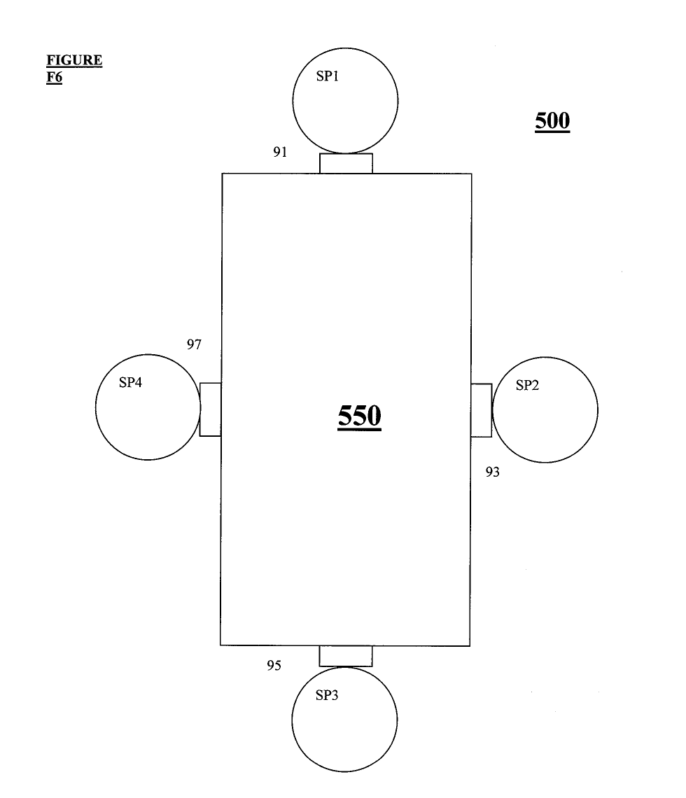

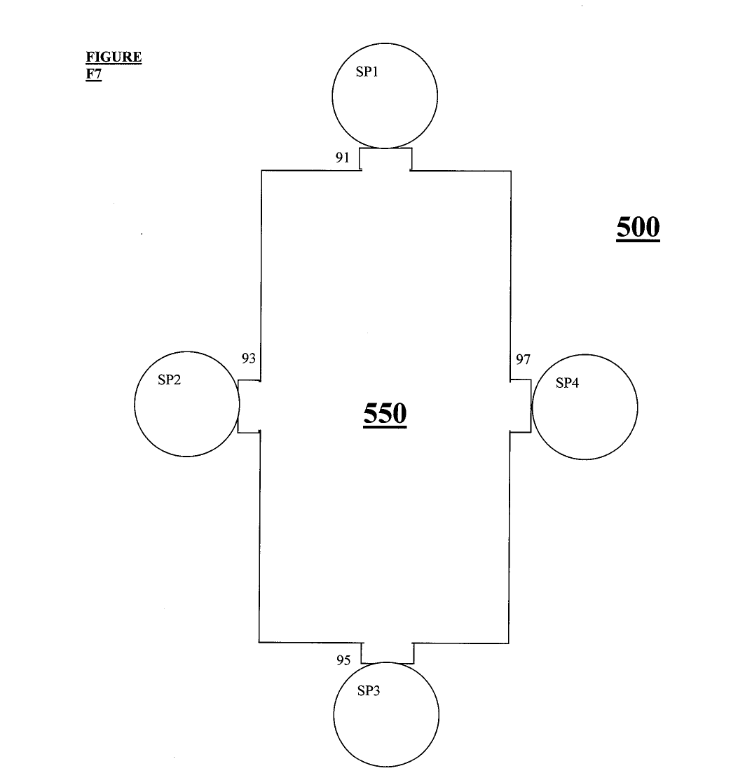

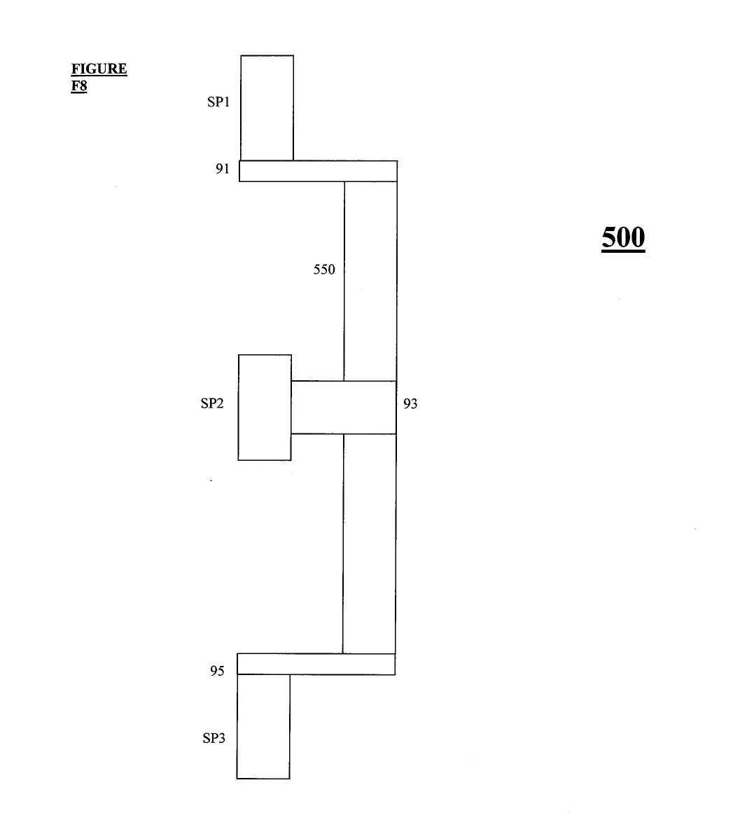

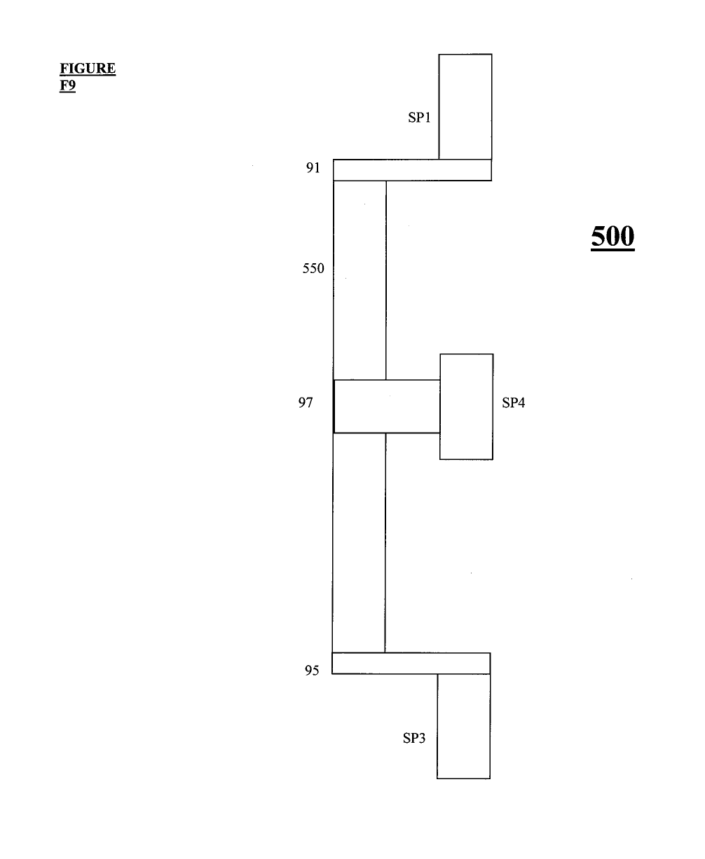

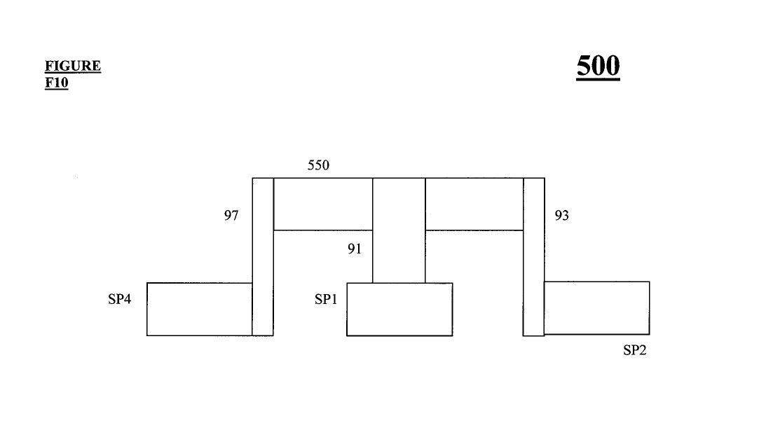

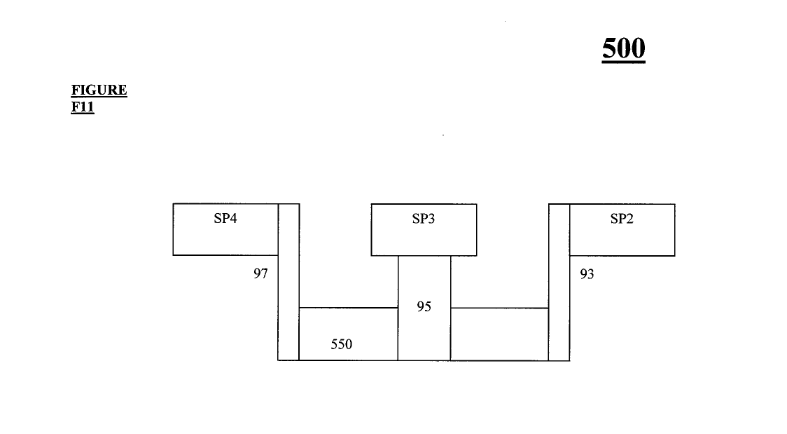

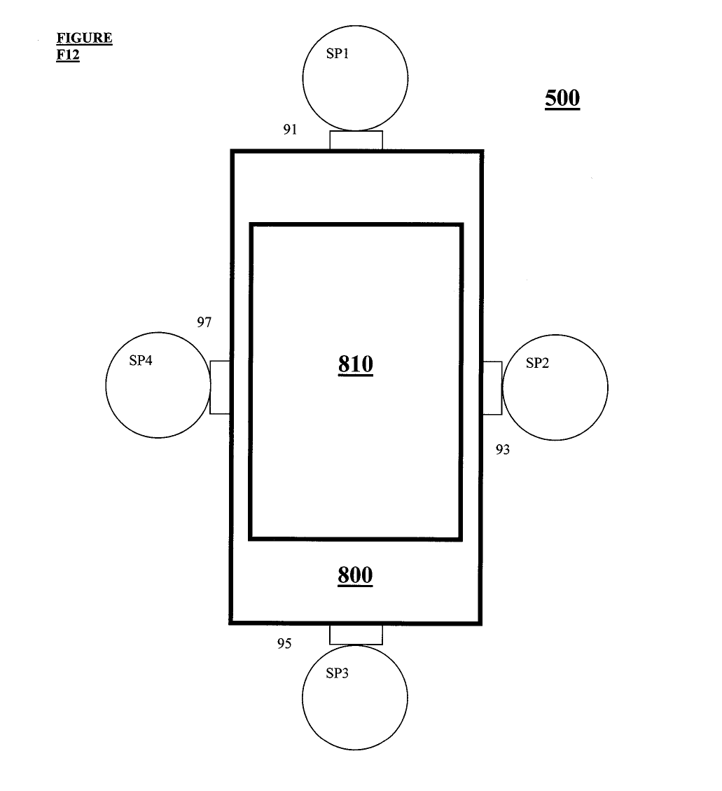

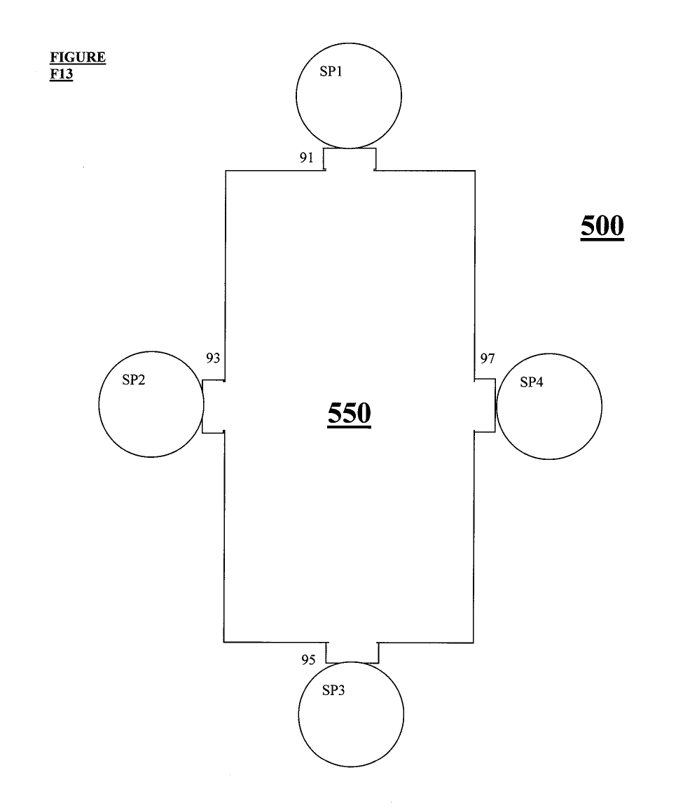

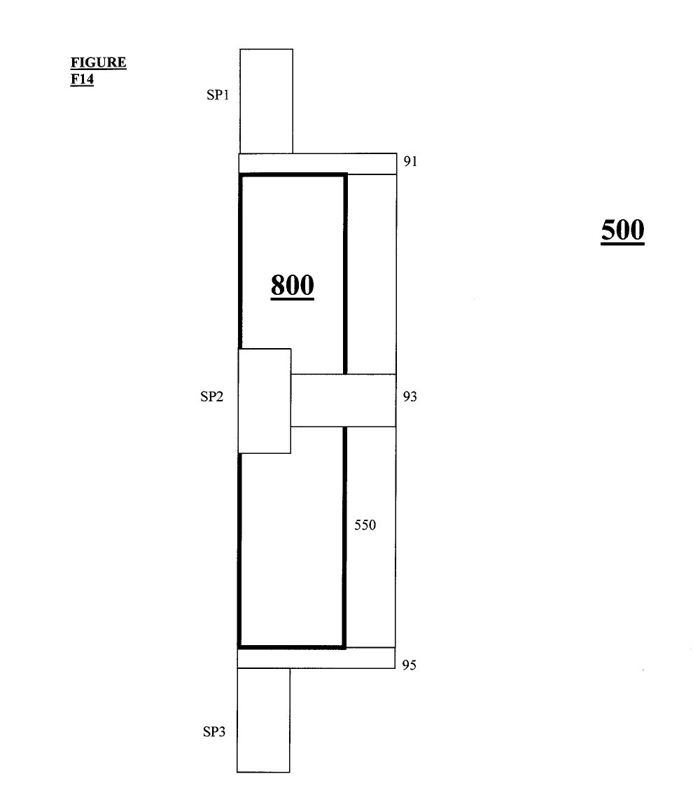

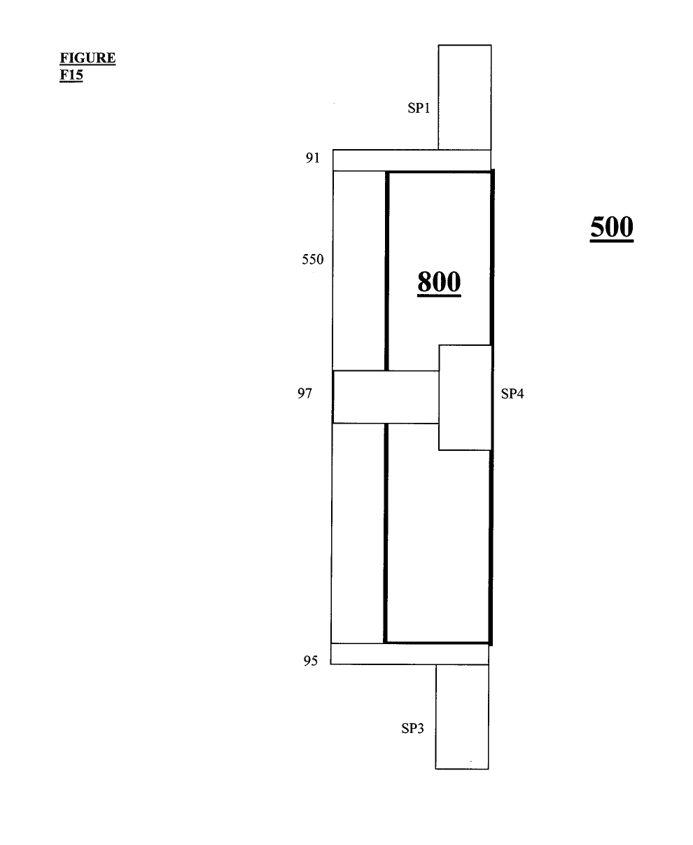

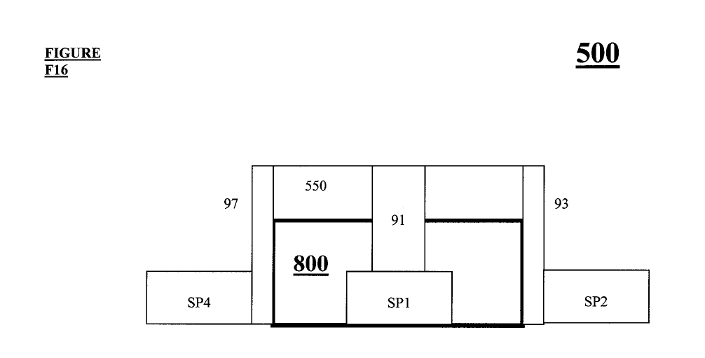

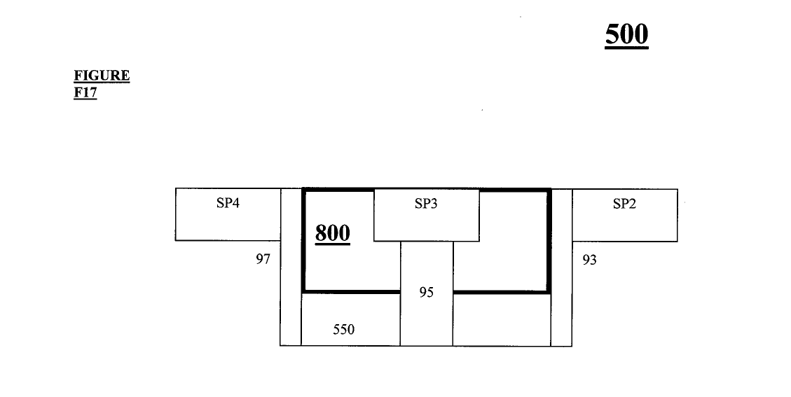

Nobuhiko et al patent application publication 2005-0212909 published on Sep. 29, 2005 and entitled Remote video display method, video acquisition device, method thereof, and program thereof states as follows: “According to the usage pattern, when the direction of the partial object that the user wants to see first is predetermined, it is necessary that the respective pieces of camera identification information be made to correspond to north, south, east and west directions, for example, north, north-east, east, . . . directions. The correspondences between the camera identification information and the north, south, east and west directions may be defined by predetermining the shooting direction of the camera device of each camera identification information and placing the remote image sensing device 2 accordingly. In some case, however, such placement of the remote image sensing device 1 is time-consuming. To avoid this, as shown in FIG. 11, camera information measuring means 25 is provided in each of the camera devices 2.sub.1 to 2.sub.N, and the angle of the shooting direction with respect to true north is measured by a magnetic compass or similar direction sensor 25a of the camera information measuring means 25 to obtain the information about the shooting direction of each camera device in north, south, east, or west direction. In the illustrated example, a tilt angle sensor 25b as by a gravitational accelerometer is also provided, by which is detected a value .DELTA.y that represents, in terms of the number of pixels on the frame of the captured image, the angle of the shooting direction to the horizontal plane, that is, the angle (angle of elevation/depression) of the y-axis of the image sensor device 7 of the camera 21. The north, south, east or west direction and the tilt angle .DELTA.yn measured by the camera information measuring means 25 are sent, together with the camera identification information IDn of the camera device 2.sub.n (n=1, . . . , N), to the image capturing device 1 by the signal sending/receiving means 23 as indicated by the term in parentheses in FIGS. 11 and 13. The image capturing device 1 receives from each camera device 2.sub.n its identification information IDn, north, south, east or west direction and tilt angle .DELTA.yn by the signal sending/receiving means 15, and stores them in the camera direction storage means 19 in correspondence to the identification IDn as shown in FIG. 16, for instance.”

Rickaby patent application publication 2005-0279577 published on Dec. 22, 2005 and entitled Stairlift states as follows: “In this mode of operation the control unit maintains the seat level by use of the sensor 19 which is in the form of a Gravitational Accelerometer to measure seat angle relative to the vertical. The lift is run slowly up on the rail with the control unit recording data representing both the position of the levelling motor and the relative position of the lift along the rail at all positions on the rail eg by counting teeth on the rack. Other information needed to operate the lift is also recorded such as desired running speed, positions of the end stops etc. In this mode of operation the seat is maintained level by driving the levelling motor 16 to follow the positions recorded during the program mode. Main drive speed, end stops etc are also controlled using the recorded data. The Gravitational Accelerometer is not used to maintain level during this mode but is used as a failsafe device, stopping the lift if the seat fails to be maintained within a defined level range.”

Epley et al patent application publication 2007-0299362 published on Dec. 27, 2007 and entitled Stimulus-evoked vestibular evaluation system, method and apparatus states as follows: “One or more (and preferably bilateral) eye video cameras 14, which also can be integrated into the hEADet, are configured to digitally record a video of the subject's right and/or left ocular, e.g. nystagmatic, response to the ear pressure and/or sound stimuli. One or more positional/inertial sensors 16, which can take the form of an angular or gravitational accelerometer and which typically is positioned on the subject's torso such as a shoulder but which can alternatively be positioned on the subject's head, are used in accordance with the invention to monitor the subject's head or torso postural sway response to the stimuli.”

Meitzler et al patent application publication 2009-0143106 published on Jun. 4, 2009 and entitled Hand-Held Communication Device with Auxiliary Input Apparatus, and Method states as follows: “Accordingly, the sensor assembly 200 is well suited for use as an antenna selector so that the device circuitry can use the information regarding the detected hand grip, such as associated with different housing orientations in different modes of operation of the device 100, to select the appropriate antenna or combination of antennas to provide the best signal strength for the wireless device 100. In another aspect, the sensor assembly 200 may be used as an orientation sensor. Present art uses a gravitational pull sensor to determine if the phone 100 is held more horizontally such as with images displayed on the screen 124 in the landscape mode or more vertically such as with images displayed on the screen 124 in the document mode. As indicated, in most cases the user holds the phone 100 differently when using the phone 100 in the different modes. Thus, the tactile pressure sensor 200 described herein can be used instead of or in addition to present gravitational and accelerometer orientation technology to better define to the internal processing circuitry not only the gravitational pull forces on the device, but also the hand grip location and/or force on the device. For example, two sensor assemblies 200 mounted at different locations about the phone housing 102 together will give the device circuitry a better chance of predicting the user's intended use for the device 100 allowing it to better predict the mode in which the user is employing the device 100. Use of a gravitational sensor alone may not accurately predict where the hand is holding the phone device 100. Accordingly, without positive information regarding the user's grip, the phone's circuitry will not as likely be able to accurately predict where the user is holding the phone 100. Thus, if the wireless device 100 has several antennas to choose from whereby each antenna is more resistant to negative hand grip effects of a specific grip, and it knows the grip that is being applied to the housing 102, it can choose the best antenna on the phone 100 to negate hand grip losses without needing to measure receiver performance from each available antenna (which is a long utilized methodology in the art).”

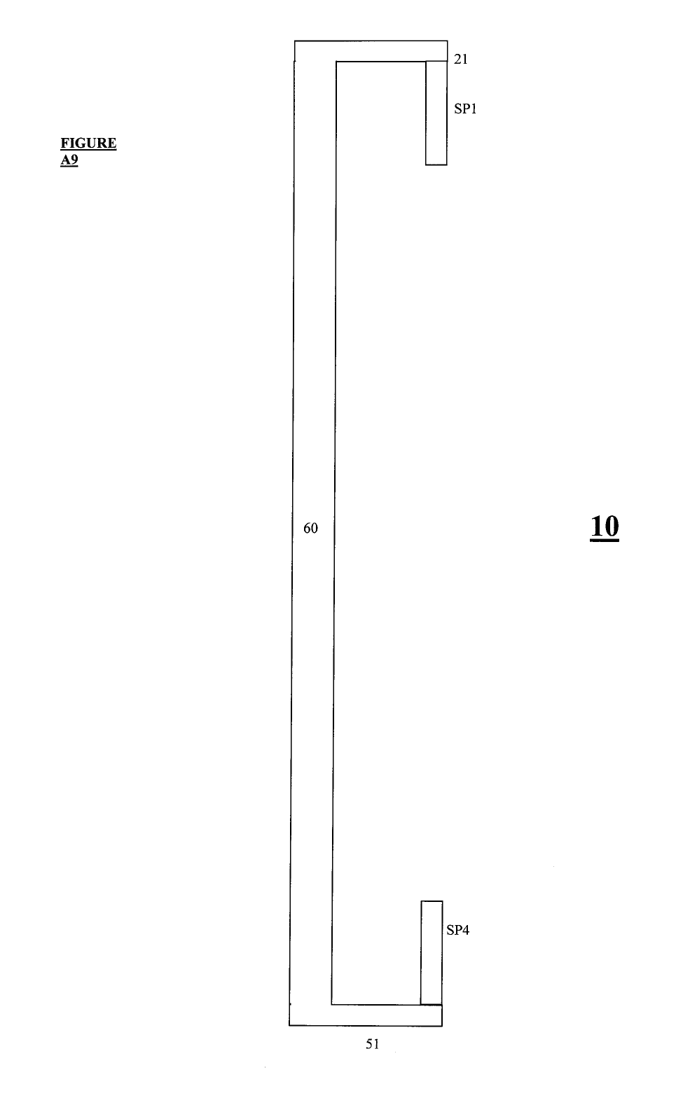

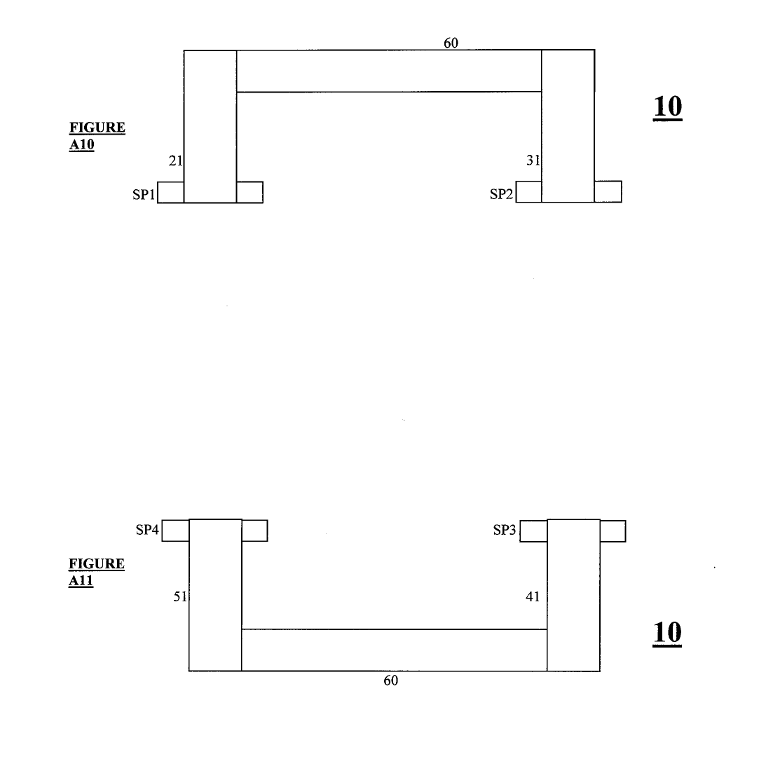

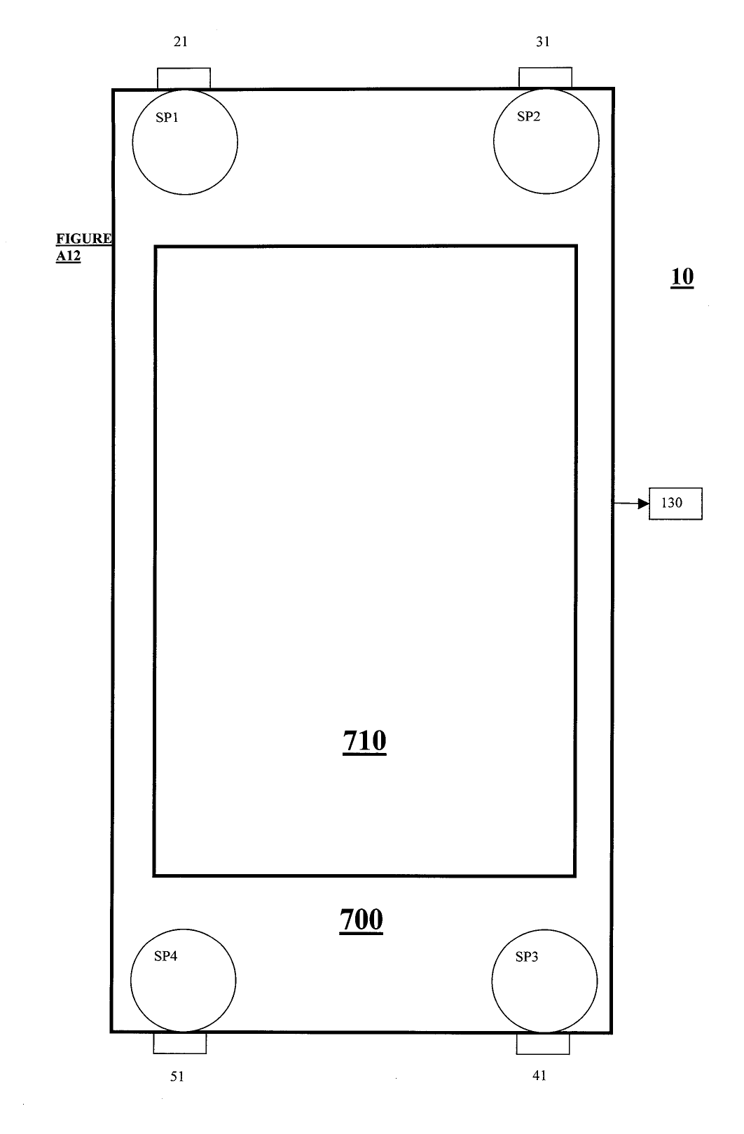

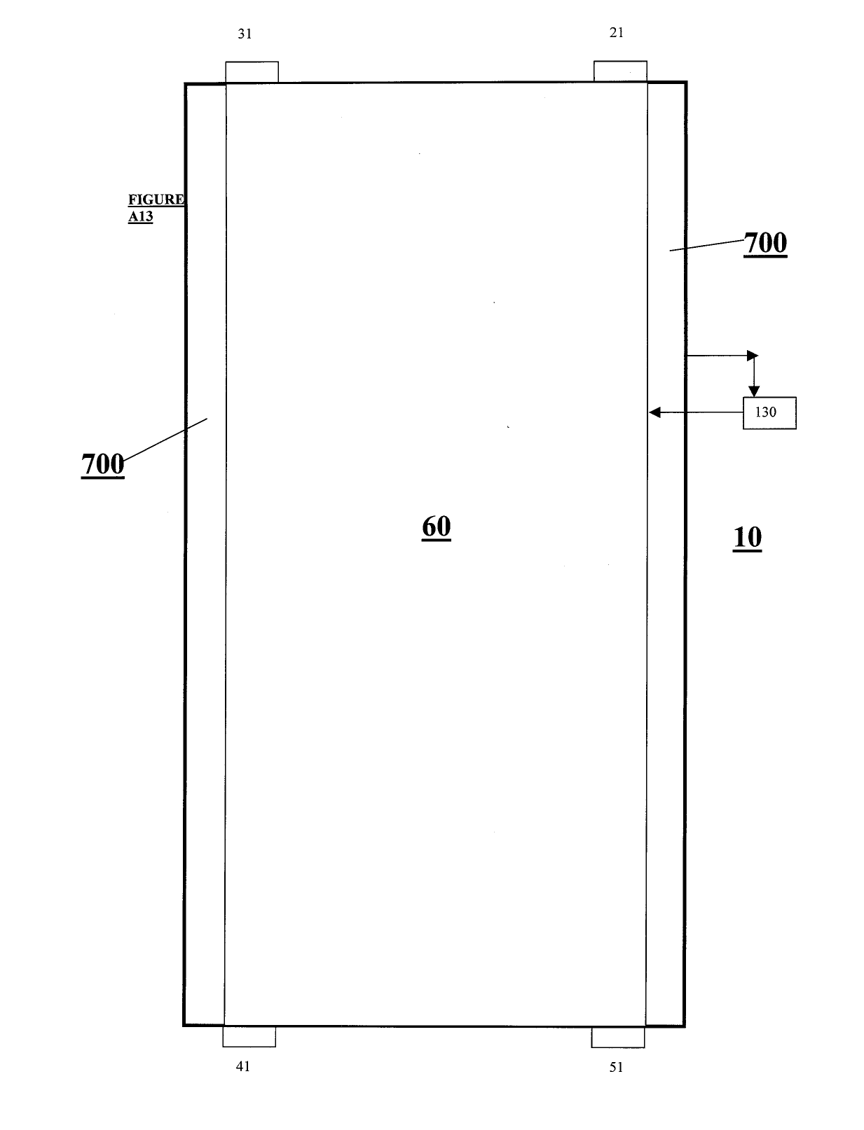

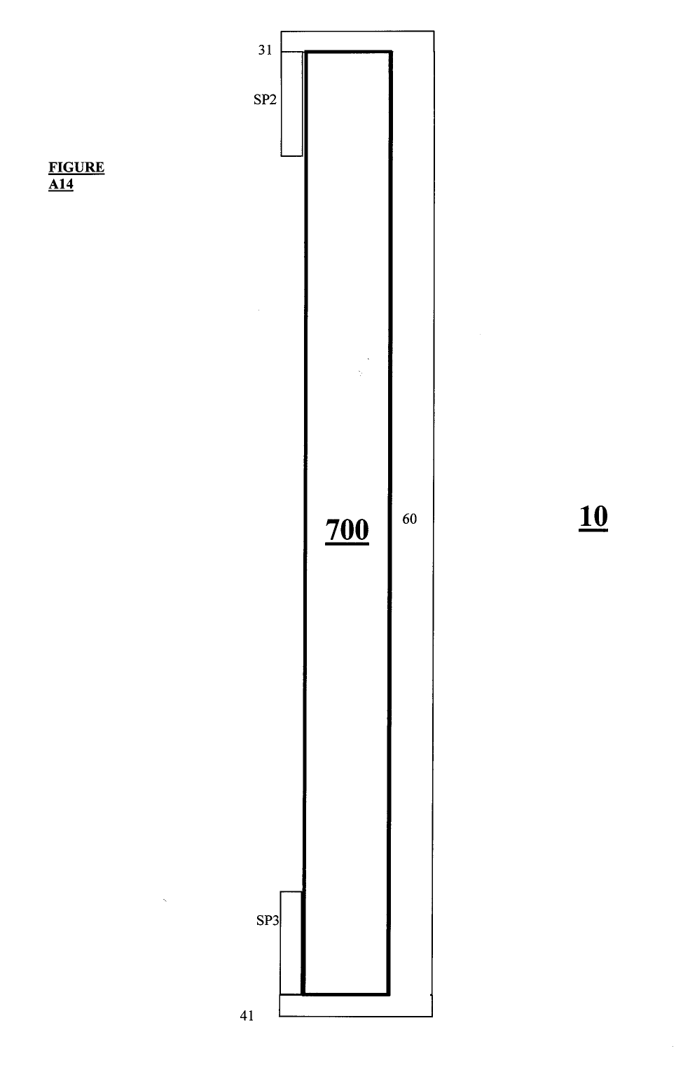

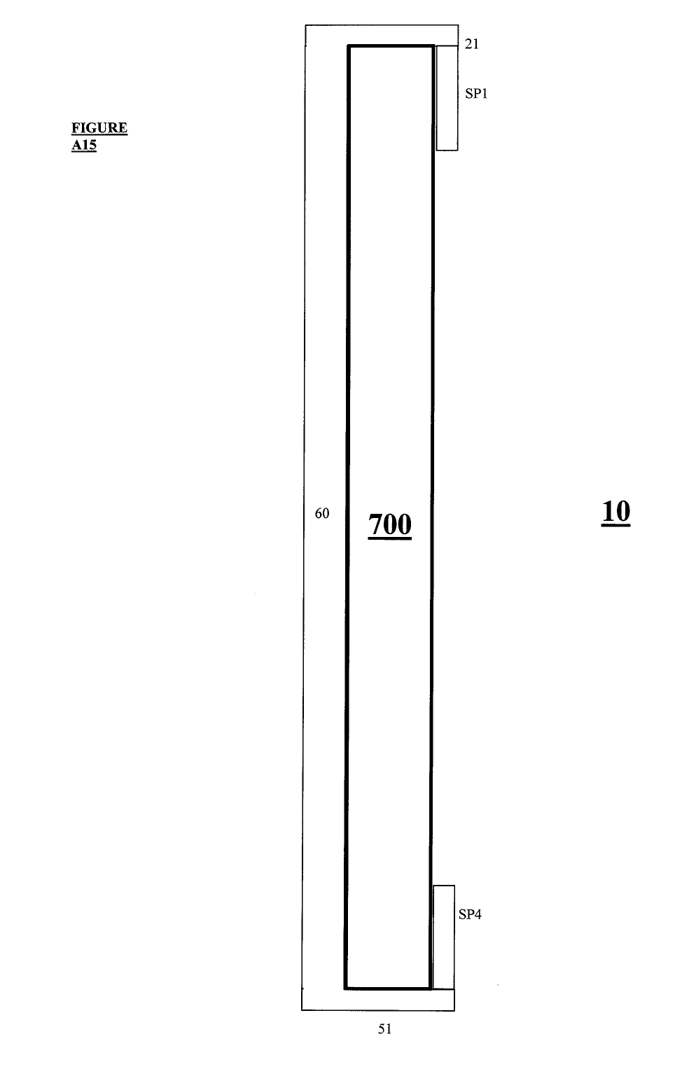

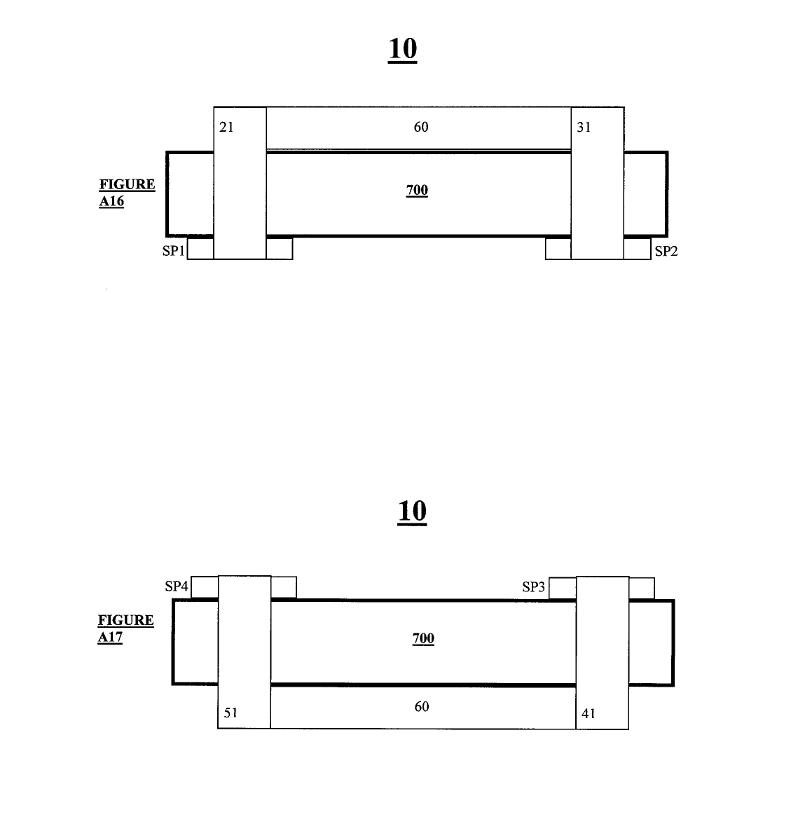

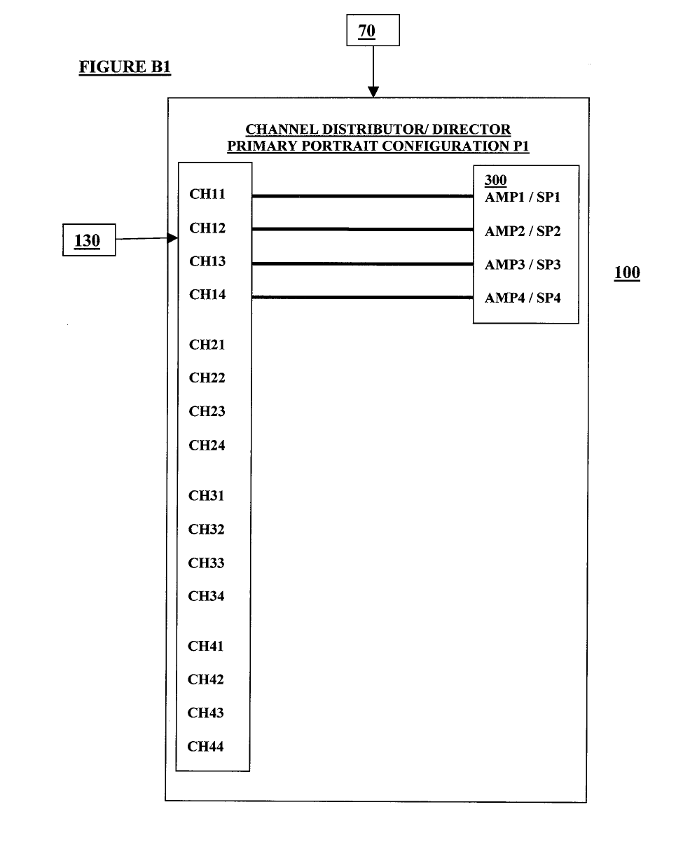

Lin et al patent application publication 2011-0102149 published on May 5, 2011 and entitled SYSTEM AND METHOD FOR OPERATING AN RFID SYSTEM WITH HEAD TRACKING states as follows: “In FIG. 3, the head 312 of the user 310 is positioned facing the tracking device 340. The left and right light beams 334, 338 are received by the sensor 350. From observation of the positioning of the sources of the left and right light beams 334, 338, namely, the left and right emitters 332, 336, the tracking device 340 can determine various characteristics of the present state of the head 312. For example, in conjunction with a gravitational gyroscope or other gravitational accelerometer or sensor, the head tracking device can determine whether the left and right emitters 332, 336 are on the same level relative to the surface of the Earth. Thus, the tracking device 340 can determine the angle of incline of the head 312 from positioning of the emitters 332, 336.”

Lemire et al patent application publication 2011-0231996 published on Sep. 29, 2011 and entitled Hospital Bed states as follows: “Currently, the angular position of the patient can be determined by measuring the patient's current position with respect to a plane of reference (e.g., the floor or the bed frame). This technique, however, suffers from the drawback that any misalignment in the frame of reference severely affects the integrity of the sensed angular position. Another method for inclinometry is by way of gravitational accelerometers. When the accelerometer is in a stationary position, the only force acting on it is the vertical gravitational force having a constant acceleration. Accordingly, the angular position of the patient can be calculated by measuring the deviation in the inclination angle between the inclination axis and the vertical gravitational force.”

While the aforementioned prior art references describe the use of gravitational accelerometers in various applications, such references do not disclose applicant's claimed invention.

Objects of the present invention are to provide:

An electronic-acoustic device that is capable of providing programmable mono-phonic, stereo-phonic, tri-phonic, and quadri-phonic sound outputs in its primary portrait orientation, its primary landscape orientation, its secondary portrait orientation, and its secondary landscape orientation in response to a spatial orientation sensor.

An electronic-acoustic device that is capable of providing dramatic multi-channel sound effects in its primary portrait orientation, its primary landscape orientation, its secondary portrait orientation, and its secondary landscape orientation in response to a spatial orientation sensor.

### FEATURES OF THE PRESENT INVENTION

An electronic-acoustic device being responsive to at least one input signal and comprising: A spatial orientation sensor for detecting the vertical direction; A sound channel distributor/director for providing a plurality of output signals, and being jointly responsive to said at least one input signal and to said spatial orientation sensor; A multi-channel amplifier being responsive to said plurality of output signals of said sound channel distributor/director; A loudspeaker array being responsive to said multi-channel amplifier for producing different sets of output sounds in the various spatial orientations of said device.

Features of the present invention are as follows:

The Electronic-Acoustic Device of the present invention may be configured in its portrait orientations and in its landscape orientations to provide a left sound output and a right sound output utilizing a loudspeaker array in response to a spatial orientation sensor.

The Electronic-Acoustic Device of the present invention may be configured in its portrait orientations and in its landscape orientations to provide a left sound output, a center or middle sound output, and a right sound output utilizing a loudspeaker array in response to a spatial orientation sensor.

The Electronic-Acoustic Device of the present invention may be programmed in its portrait orientations and in its landscape orientations to provide various combinations of left and right sound outputs utilizing a loudspeaker array in response to a spatial orientation sensor.

The Electronic-Acoustic Device of the present invention may be programmed in its portrait orientations and in its landscape orientations to provide various combinations of left, right and center or middle sound outputs utilizing a loudspeaker array in response to a spatial orientation sensor.

The Electronic-Acoustic Device of the present invention may be configured in its portrait orientations and in its landscape orientations to secure and hold an iphone, an ipod, a smart phone, a cell phone or any other similar device being surrounded by its loudspeaker array.

The Electronic-Acoustic Device of the present invention may be configured in its portrait orientations and in its landscape orientations to secure and hold an iphone, an ipod, a smart phone, a cell phone or any other similar device surrounded by its left sound output loudspeakers and its right sound output loudspeakers.

The Electronic-Acoustic Device of the present invention may be configured in its portrait orientations and in its landscape orientations to secure and hold an iphone, an ipod, a smart phone, a cell phone or any other similar device surrounded by its left sound output loudspeaker, its middle or center sound output loudspeakers, and its right sound output loudspeaker.

The Electronic-Acoustic Device of the present invention may be programmed in its portrait orientations and in its landscape orientations to provide various combinations of sound outputs from its left sound output loudspeakers and its right sound output loudspeakers wherein the sound outputs are derived from input signals provided by an iphone, an ipod, a smart phone, a cell phone or any other similar device.

The Electronic-Acoustic Device of the present invention may be programmed in its portrait orientations and in its landscape orientations to provide various combinations of sound outputs from its left sound loudspeaker, its middle or center sound loudspeakers, and its right sound loudspeaker wherein the sound outputs are derived from input signals provided by an iphone, an ipod, a smart phone, a cell phone or any other similar device.

### BRIEF DESCRIPTION OF THE DRAWINGS

The above and other objects, advantages and features of the present invention will be further appreciated from a reading of the following detailed description in conjunction with the drawing in which:

FIG. A1 is a front view of Electronic-Acoustic Device 10 in the primary portrait orientation P1 according to the present invention.

FIG. A2 is a front view of Electronic-Acoustic Device 10 in the primary landscape orientation L1 according to the present invention.

FIG. A3 is a front view of Electronic-Acoustic Device 10 in the secondary portrait orientation P2 according to the present invention.

FIG. A4 is a front view of Electronic-Acoustic Device 10 in the secondary landscape orientation L2 according to the present invention.

FIG. A5 is a partially cross-sectional front view of Electronic-Acoustic Device 10 according the present invention.

FIG. A6 is a front view of channel distributor/director 100 according to the present invention.

FIG. A7A is a front view of Electronic-Acoustic Device 10 according to the present invention.

FIG. A7B is a rear view of Electronic-Acoustic Device 10 according to the present invention.

FIG. A8 is a right side view of Electronic-Acoustic Device 10 according to the present invention.

FIG. A9 is a left side view of Electronic-Acoustic Device 10 according to the present invention.

FIG. A10 is a top view of Electronic-Acoustic Device 10 according to the present invention.

FIG. A11 is a bottom view of Electronic-Acoustic Device 10 according to the present invention.

FIG. A12 is a front view of Electronic-Acoustic Device 10 and attached electronic device 700 according to the present invention.

FIG. A13 is a rear view of Electronic-Acoustic Device 10 and attached electronic device 700 according to the present invention.

FIG. A14 is a right side view of Electronic-Acoustic Device 10 and attached electronic device 700 according to the present invention.

FIG. A15 is a left side view of Electronic-Acoustic Device 10 and attached electronic device 700 according to the present invention.

FIG. A16 is a top view of Electronic-Acoustic Device 10 and attached electronic device 700 according to the present invention.

FIG. A17 is a bottom view of Electronic-Acoustic Device 10 and attached electronic device 700 according to the present invention.

FIG. B1 is a front view of channel distributor/director 100 in the primary portrait operating configuration according to the present invention.

FIG. B2 is a front view of Electronic-Acoustic Device 10 in the primary portrait orientation P1 according to the present invention.

FIG. B3 is a front view of channel distributor/director 100 in the primary landscape operating configuration according to the present invention.

FIG. B4 is a front view of Electronic-Acoustic Device 10 in the primary landscape orientation L1 according to the present invention.

FIG. B5 is a front view of channel distributor/director 100 in the secondary portrait operating configuration according to the present invention.

FIG. B6 is a front view of Electronic-Acoustic Device 10 in the secondary portrait orientation P2 according to the present invention.

FIG. B7 is a front view of channel distributor/director 100 in the secondary landscape operating configuration according to the present invention.

FIG. B8 is a front view of Electronic-Acoustic Device 10 in the secondary landscape orientation L2 according to the present invention.

FIG. C1 is a front view of channel distributor/director 100 in the primary portrait operating configuration according to the present invention.

FIG. C2 is a front view of Electronic-Acoustic Device 10 in the primary portrait orientation P1 according to the present invention.

FIG. C3 is a front view of channel distributor/director 100 in the primary landscape operating configuration according to the present invention.

FIG. C4 is a front view of Electronic-Acoustic Device 10 in the primary landscape orientation L1 according to the present invention.

FIG. D1 is a front view of channel distributor/director 100 in the primary portrait operating configuration according to the present invention.

FIG. D2 is a front view of Electronic-Acoustic Device 10 in the primary portrait orientation P1 according to the present invention.

FIG. D3 is a front view of channel distributor/director 100 in the primary landscape operating configuration according to the present invention.

FIG. D4 is a front view of Electronic-Acoustic Device 10 in the primary landscape orientation L1 according to the present invention.

FIG. E1 is Table P1 with other examples of channels CH11-CH14 of FIG. B1 according to the present invention.

FIG. E2 is Table L1 with other examples of channels CH21-CH24 of FIG. B3 according to the present invention.

FIG. E3 is Table P2 with other examples of channels CH31-CH34 of FIG. B5 according to the present invention.

FIG. E4 is Table L2 with other examples of channels CH41-CH44 of FIG. B7 according to the present invention.

FIG. F1 is partially cross-sectional front view of Electronic-Acoustic Device 500 according the present invention.

FIG. F2 is a front view of channel distributor/director 590 in the primary portrait operating configuration according to the present invention.

FIG. F3 is a front view of Electronic-Acoustic Device 500 in the primary portrait orientation P1 according to the present invention.

FIG. F4 is a front view of channel distributor/director 590 in the primary landscape operating configuration according to the present invention.

FIG. F5 is a front view of Electronic-Acoustic Device 500 in the primary landscape orientation L1 according to the present invention.

FIG. F6 is front view of Electronic-Acoustic Device 500 according the present invention.

FIG. F7 is rear view of Electronic-Acoustic Device 500 according the present invention.

FIG. F8 is right side view of Electronic-Acoustic Device 500 according the present invention.

FIG. F9 is left side view of Electronic-Acoustic Device 500 according the present invention.

FIG. F10 is top view of Electronic-Acoustic Device 500 according the present invention.

FIG. F11 is bottom view of Electronic-Acoustic Device 500 according the present invention.

FIG. F12 is front view of Electronic-Acoustic Device 500 according the present invention.

FIG. F13 is rear view of Electronic-Acoustic Device 500 according the present invention.

FIG. F14 is right side view of Electronic-Acoustic Device 500 according the present invention.

FIG. F15 is left side view of Electronic-Acoustic Device 500 according the present invention.

FIG. F16 is top view of Electronic-Acoustic Device 500 according the present invention.

FIG. F17 is bottom view of Electronic-Acoustic Device 500 according the present invention.

### DETAILED DESCRIPTION OF THE INVENTION

### FIGS. A1 Through A17

FIG. A1 is a front view of Electronic-Acoustic Device 10 in the primary portrait orientation P1 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the Y2 direction.

FIG. A2 is a front view of Electronic-Acoustic Device 10 in the primary landscape orientation L1 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the X2 direction.

FIG. A3 is a front view of Electronic-Acoustic Device 10 in the secondary portrait orientation P2 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the Y1 direction.

FIG. A4 is a front view of Electronic-Acoustic Device 10 in the secondary landscape orientation L2 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the X1 direction.

FIG. A5 is a partially cross-sectional front view of Electronic-Acoustic Device 10 according the present invention. Electronic-Acoustic Device 10 comprises: loudspeakers SP1, SP2, SP3, SP4; loudspeaker holding or securing means 21, 31, 41, 51; housing 60; rechargeable power pack 200; automatic orientation detector/sensor 70; channel distributor/director 100; multi-channel amplifier 300. Rechargeable power pack 200 receives power from external source 120. Channel distributor/director 100 receives input signals from signal source 130. Rechargeable power pack 200 powers: automatic orientation detector/sensor 70 via line 210; channel distributor/director 100 via line 220; multi-channel amplifier 300 via line 230. Automatic orientation detector/sensor 70 feeds signals to channel distributor/director 100 via line 72. Channel distributor/director 100 feeds signals to multi-channel amplifier 300 via line 110. Multi-channel amplifier 300 feeds signals to: loudspeaker SP1 via line 310; loudspeaker SP2 via line 320; loudspeaker SP3 via line 330; loudspeaker SP4 via line 340. Automatic orientation detector/sensor 70 may comprise an orientation sensor or an inclinometer or a positioning indicator or a tilt angle sensor or two-axis gravitational accelerometer 71. Also shown is gravity vector 80.

FIG. A6 is a front view of channel distributor/director 100 according to the present invention. Channel distributor/director 100 re-directs signals on active channels CH11 to CH44 as provided by input signal source 130. Channel distributor/director 100 provides combinations of signals to amplifier/loudspeaker pairs: AMP1/SP1 to AMP4/SP4. Channel distributor/director 100 receives orientation or position signals from automatic orientation detector/sensor 70 and re-directs the input signals from the active channels to the pre-chosen or pre-programmed amplifier/loudspeaker pairs.

FIG. A7A is a front view of Electronic-Acoustic Device 10 according to the present invention. Electronic-Acoustic Device 10 comprises: loudspeakers SP1, SP2, SP3, SP4; loudspeaker holding or securing means 21, 31, 41, 51; and the front side of housing 60.

FIG. A7B is a rear view of Electronic-Acoustic Device 10 according to the present invention. Electronic-Acoustic Device 10 comprises: loudspeakers SP1, SP2, SP3, SP4; loudspeaker holding or securing means 21, 31, 41, 51; and the rear side of housing 60.

FIG. A8 is a ride side view of Electronic-Acoustic Device 10 according to the present invention. FIG. A8 shows: loudspeakers SP2, SP3; loudspeaker holding or securing means 31, 41; and the right side of housing 60.

FIG. A9 is a left side view of Electronic-Acoustic Device 10 according to the present invention. FIG. A9 shows: loudspeakers SP1, SP4; loudspeaker holding or securing means 21, 51; and the left side of housing 60.

FIG. A10 is a top view of Electronic-Acoustic Device 10 according to the present invention. FIG. A10 shows: loudspeakers SP1, SP2; loudspeaker holding or securing means 21, 31; and the top side of housing 60.

FIG. A11 is a bottom view of Electronic-Acoustic Device 10 according to the present invention. FIG. A11 shows: loudspeakers SP3, SP4; loudspeaker holding or securing means 41, 51; and the bottom side of housing 60.

FIG. A12 is a front view of Electronic-Acoustic Device 10 and attached electronic device 700 according to the present invention. FIG. A12 shows: loudspeakers SP1, SP2, SP3, SP4; loudspeaker holding or securing means 21, 31, 41, 51; and the front of attached electronic device 700. Attached Electronic Device 700 comprises front monitor screen 710. Attached Electronic Device 700 may provide signals to signal source 130 for processing by channel distributor/director 100 of Electronic-Acoustic Device 10 as hereinbefore described.

FIG. A13 is a rear view of Electronic-Acoustic Device 10 and attached electronic device 700 according to the present invention. FIG. A13 shows: loudspeaker holding or securing means 21, 31, 41, 51; the rear side of housing 60; and the rear side of attached electronic device 700. Attached Electronic Device 700 may provide signals to signal source 130 for processing by channel distributor/director 100 of Electronic-Acoustic Device 10 as hereinbefore described.

FIG. A14 is a right side view of Electronic-Acoustic Device 10 and attached electronic device 700 according to the present invention. FIG. A14 shows: loudspeakers SP2, SP3; loudspeaker holding or securing means 31, 41; the right side of housing 60; and the right side of attached electronic device 700.

FIG. A15 is a left side view of Electronic-Acoustic Device 10 and attached electronic device 700 according to the present invention. FIG. A14 shows: loudspeakers SP1, SP4; loudspeaker holding or securing means 21, 51; the left side of housing 60; and the left side of attached electronic device 700.

FIG. A16 is a top view of Electronic-Acoustic Device 10 and attached electronic device 700 according to the present invention. FIG. A16 shows: loudspeakers SP1, SP2; loudspeaker holding or securing means 21, 31; the top side of housing 60; and the top side of attached electronic device 700.

FIG. A17 is a bottom view of Electronic-Acoustic Device 10 and attached electronic device 700 according to the present invention. FIG. A17 shows: loudspeakers SP3, SP4; loudspeaker holding or securing means 41, 51; the bottom side of housing 60; and the bottom side of attached electronic device 700.

### FIGS. B1 Through B8

FIG. B1 is a front view of channel distributor/director 100 in the primary portrait operating configuration according to the present invention. Channel distributor/director 100 receives input signals from active channels CH11 to CH14 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. B2 is a front view of Electronic-Acoustic Device 10 in the primary portrait orientation P1 according to the present invention. Electronic-Acoustic Device 10 comprises: loudspeakers SP1, SP2, SP3, SP4; loudspeaker holding or securing means 21, 31, 41 and 51; housing 60. Also shown are gravitational accelerometer axes 71 being X1, X2, Y1 and Y2 and gravity vector 80 in this case corresponding to the Y2 direction. More specifically, loudspeaker SP1 on the upper left of Electronic-Acoustic Device 10 provides the sound output corresponding to the input signal from channel CH11; loudspeaker SP2 on the upper right of Electronic-Acoustic Device 10 provides the sound output corresponding to the input signal from channel CH12; loudspeaker SP3 on the lower right of Electronic-Acoustic Device 10 provides the sound output corresponding to the input signal from channel CH13; and loudspeaker SP4 on the lower left of Electronic-Acoustic Device 10 provides the sound output corresponding to the input signal from channel CH14; all of the aforementioned being under the joint control of automatic orientation detector/sensor 70 and channel distributor/director 100.

FIG. B3 is a front view of channel distributor/director 100 in the primary landscape operating configuration according to the present invention. Channel distributor/director 100 receives input signals from active channels CH21 to CH24 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. B4 is a front view of Electronic-Acoustic Device 10 in the primary landscape orientation L1 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the X2 direction. More specifically, loudspeaker SP2 on the upper left of Electronic-Acoustic Device 10 provides the sound output corresponding to the input signal from channel CH22; loudspeaker SP3 on the upper right of Electronic-Acoustic Device 10 provides the sound output corresponding to the input signal from channel CH23; loudspeaker SP4 on the lower right of Electronic-Acoustic Device 10 provides the sound output corresponding to the input signal from channel CH24; loudspeaker SP1 on the lower left of Electronic-Acoustic Device 10 provides the sound output corresponding to the input signal from channel CH21; all of the aforementioned being under the joint control of automatic orientation detector/sensor 70 and channel distributor/director 100.

FIG. B5 is a front view of channel distributor/director 100 in the secondary portrait operating configuration according to the present invention. Channel distributor/director 100 receives input signals from active channels CH31 to CH34 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. B6 is a front view of Electronic-Acoustic Device 10 in the secondary portrait orientation P2 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the Y1 direction. More specifically, loudspeaker SP3 on the upper left of Electronic-Acoustic Device 10 provides the sound output corresponding to the input signal from channel CH33; loudspeaker SP4 on the upper right of Electronic-Acoustic Device 10 provides the sound output corresponding to the input signal from channel CH34; loudspeaker SP1 on the lower right of Electronic-Acoustic Device 10 provides the sound output corresponding to the input signal from channel CH31; loudspeaker SP2 on the lower left of Electronic-Acoustic Device 10 provides the sound output corresponding to the input signal from channel CH32; all of the aforementioned being under the joint control of automatic orientation detector/sensor 70 and channel distributor/director 100.

FIG. B7 is a front view of channel distributor/director 100 in the secondary landscape operating configuration according to the present invention. Channel distributor/director 100 receives input signals from active channels CH41 to CH44 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. B8 is a front view of Electronic-Acoustic Device 10 in the secondary landscape orientation L2 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the X1 direction. More specifically, loudspeaker SP4 on the upper left of Electronic-Acoustic Device 10 provides the sound output corresponding to the input signal from channel CH44; loudspeaker SP1 on the upper right of Electronic-Acoustic Device 10 provides the sound output corresponding to the input signal from channel CH41; loudspeaker SP2 on the lower right of Electronic-Acoustic Device 10 provides the sound output corresponding to the input signal from channel CH42; and loudspeaker SP3 on the lower left of Electronic-Acoustic Device 10 provides the sound output corresponding to the input signal from channel CH43; all of the aforementioned being under the joint control of automatic orientation detector/sensor 70 and channel distributor/director 100.

### FIGS. C1 Through C4

FIG. C1 is a front view of channel distributor/director 100 in the primary portrait operating configuration according to the present invention. Channel distributor/director 100 receives input signals from active channels CH11 and CH12 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. C2 is a front view of Electronic-Acoustic Device 10 in the primary portrait orientation P1 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the Y2 direction. More specifically, loudspeaker SP1 on the upper left of Electronic-Acoustic Device 10 provides the sound output corresponding to the input signal from channel CH11; loudspeaker SP2 on the upper right of Electronic-Acoustic Device 10 provides the sound output corresponding to the input signal from channel CH12; loudspeaker SP3 on the lower right of Electronic-Acoustic Device 10 provides the sound output corresponding to the input signal from channel CH12; loudspeaker SP4 on the lower left of Electronic-Acoustic Device 10 provides the sound output corresponding to the input signal from channel CH11; all of the aforementioned being under the joint control of automatic orientation detector/sensor 70 and channel distributor/director 100. This loudspeaker output operating configuration would be the typical left channel/right channel stereo configuration with moderate channel separation in the primary portrait orientation P1.

FIG. C3 is a front view of channel distributor/director 100 in the primary landscape operating configuration according to the present invention. Channel distributor/director 100 receives input signals from active channels CH11 and CH12 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. C4 is a front view of Electronic-Acoustic Device 10 in the primary landscape orientation L1 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the X2 direction. More specifically, loudspeaker SP2 on the upper left of Electronic-Acoustic Device 10 provides the sound output corresponding to the input signal from channel CH11; loudspeaker SP3 on the upper right of Electronic-Acoustic Device 10 provides the sound output corresponding to the input signal from channel CH12; loudspeaker SP4 on the lower right of Electronic-Acoustic Device 10 provides the sound output corresponding to the input signal from channel CH12; loudspeaker SP1 on the lower left of Electronic-Acoustic Device 10 provides the sound output corresponding to the input signal from channel CH11; all of the aforementioned being under the joint control of automatic orientation detector/sensor 70 and channel distributor/director 100. This loudspeaker output operating configuration would also be a left channel/right channel stereo configuration but with expanded channel separation in the primary landscape orientation L1.

### FIGS. D1 Through D4

FIG. D1 is a front view of channel distributor/director 100 in the primary portrait operating configuration according to the present invention. Channel distributor/director 100 receives input signals from active channels CH11 through CH24 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. D2 is a front view of Electronic-Acoustic Device 10 in the primary portrait orientation P1 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the Y2 direction. More specifically, loudspeaker SP1 on the upper left of Electronic-Acoustic Device 10 provides the sound output corresponding to the combined input signals from channels CH11+CH21; loudspeaker SP2 on the upper right of Electronic-Acoustic Device 10 provides the sound output corresponding to the combined input signals from channels CH12+CH22; loudspeaker SP3 on the lower right of Electronic-Acoustic Device 10 provides the sound output corresponding to the combined input signal from channels CH13+CH23; loudspeaker SP4 on the lower left of Electronic-Acoustic Device 10 provides the sound output corresponding to the combined input signal from channels CH14+CH24; all of the aforementioned being under the joint control of automatic orientation detector/sensor 70 and channel distributor/director 100. This loudspeaker output operating configuration would also be a left channel/right channel stereo configuration with moderate channel separation in the primary portrait orientation P1.

FIG. D3 is a front view of channel distributor/director 100 in the primary landscape operating configuration according to the present invention. Channel distributor/director 100 receives input signals from active channels CH11 through CH24 as provided by signal source 130 and distributes/re-directs such signals in response to automatic orientation detector/sensor 70 to amplifier/loudspeaker combinations: AMP1/SP1 to AMP4/SP4 as indicated by the arrows.

FIG. D4 is a front view of Electronic-Acoustic Device 10 in the primary landscape orientation L1 according to the present invention. Electronic-Acoustic Device 10 comprises: loudspeakers SP1, SP2, SP3, SP4; loudspeaker holding or securing means 21, 31, 41, 51; housing 60. Also shown are gravitational accelerometer axes 71 being X1, X2, Y1 and Y2 and gravity vector 80 in this case corresponding to the X2 direction. More specifically, loudspeaker SP2 on the upper left of Electronic-Acoustic Device 10 provides the sound output corresponding to the combined input signals from channels CH11+CH21; loudspeaker SP3 on the upper right of Electronic-Acoustic Device 10 provides the sound output corresponding to the combined input signals from channels CH12+CH22; loudspeaker SP4 on the lower right of Electronic-Acoustic Device 10 provides the sound output corresponding to the combined input signal from channels CH13+CH23; loudspeaker SP1 on the lower left of Electronic-Acoustic Device 10 provides the sound output corresponding to the combined input signal from channels CH14+CH24; all of the aforementioned being under the joint control of automatic orientation detector/sensor 70 and channel distributor/director 100. This loudspeaker output operating configuration would also be a left channel/right channel stereo configuration with expanded channel separation in the primary landscape orientation.

### FIG. E1 Through E4

FIG. E1 is Table P1 with other examples of channels CH11-CH14 in FIG. B1 being distributed/directed individually and in combination under the joint control of automatic orientation detector/sensor 70 and channel distributor/director 100 to loudspeaker/amplifier combinations AMP1/SP1-AMP4/SP4 in the primary portrait operating configuration.

FIG. E2 is Table L1 with other examples of channels CH21-CH24 in FIG. B3 being distributed/directed individually and in combination under the joint control of automatic orientation detector/sensor 70 and channel distributor/director 100 to loudspeaker/amplifier combinations AMP1/SP1-AMP4/SP4 in the primary landscape operating configuration.

FIG. E3 is Table P2 with other examples of channels CH31-CH34 in FIG. B5 being distributed/directed individually and in combination under the joint control of automatic orientation detector/sensor 70 and channel distributor/director 100 to loudspeaker/amplifier combinations AMP1/SP1-AMP4/SP4 in the secondary portrait operating configuration.

FIG. E4 is Table L2 with other examples of channels CH41-CH44 in FIG. B7 being distributed/directed individually and in combination under the joint control of automatic orientation detector/sensor 70 and channel distributor/director 100 to loudspeaker/amplifier combinations AMP1/SP1-AMP4/SP4 in the secondary landscape operating configuration.

### FIGS. F1 Through F17

FIG. F1 is partially cross-sectional front view of Electronic-Acoustic Device 500 according the present invention. Electronic-Acoustic Device 500 comprises: loudspeakers SP1, SP2, SP3, SP4; loudspeaker holding or securing means 91, 93, 95, 97; housing 550; rechargeable power pack 570; automatic orientation detector/sensor 580; channel distributor/director 590; multi-channel amplifier 600. Rechargeable power pack 570 receives its power from external source 560. Channel distributor/director 590 receives signals from signal source 650. Rechargeable power pack 570 powers: automatic orientation detector/sensor 580 via line 571; channel distributor/director 590 via line 572; multi-channel amplifier 600 via line 573. Automatic orientation detector/sensor 580 feeds signals to channel distributor/director 590 via line 581. Channel distributor/director 590 feeds signals to multi-channel amplifier 600 via line 591. Multi-channel amplifier 600 feeds signals to: loudspeaker SP1 via line 610; loudspeaker SP2 via line 620; loudspeaker SP3 via line 630; loudspeaker SP4 via line 640. Automatic orientation detector/sensor 580 may comprise an orientation sensor or an inclinometer or a positioning indicator or a tilt angle sensor or a two-axis gravitational accelerometer 582 of FIG. F1A. Also shown is gravitational vector 80.

FIG. F2 is a front view of channel distributor/director 590 in the primary portrait operating configuration according to the present invention. Channel distributor/director 590 receives input signals from active channels CH11 and CH12 as provided by signal source 650 and distributes/re-directs such signals in response to automatic orientation detector/sensor 580 to amplifier/loudspeaker combinations: AMP1/SP1 to AMP4/SP4 as indicated by the arrows.

FIG. F3 is a front view of Electronic-Acoustic Device 500 in the primary portrait orientation P1 according to the present invention. Electronic-Acoustic Device 500 comprises: loudspeakers SP1, SP2, SP3, SP4; loudspeaker holding or securing means 511, 521, 531, 541; housing 550. Also shown are gravitational accelerometer axes 582 being X1, X2, Y1 and Y2 and gravity vector 80 in this case corresponding to the Y2 direction. More specifically, loudspeaker SP1 on the upper middle of Electronic-Acoustic Device 500 provides the sound output corresponding to the combined input signals from channels CH11+CH12; loudspeaker SP2 on the right middle of Electronic-Acoustic Device 500 provides the sound output corresponding to the input signal from channel CH12; loudspeaker SP3 on the lower middle of Electronic-Acoustic Device 500 provides the sound output corresponding to the combined input signal from channels CH11+CH12; loudspeaker SP4 on the left middle of Electronic-Acoustic Device 500 provides the sound output corresponding to the input signal from channel CH11; all of the aforementioned being under the joint control of automatic orientation detector/sensor 580 and channel distributor/director 590. This loudspeaker output operating configuration provides: a left channel; a center or middle channel; and a right channel stereo configuration with moderate channel separation in the primary portrait orientation P1.

FIG. F4 is a front view of channel distributor/director 590 in the primary landscape operating configuration according to the present invention. Channel distributor/director 590 receives input signals from active channels CH11 and CH12 as provided by signal source 650 and distributes/re-directs such signals in response to automatic orientation detector/sensor 580 to amplifier/loudspeaker combinations: AMP1/SP1 to AMP4/SP4 as indicated by the arrows.

FIG. F5 is a front view of Electronic-Acoustic Device 500 in the primary landscape orientation L1 according to the present invention. Electronic-Acoustic Device 500 comprises: loudspeakers SP1, SP2, SP3, SP4; loudspeaker holding or securing means 511, 521, 531, 541; housing 550. Also shown are gravitational accelerometer axes 582 being X1, X2, Y1 and Y2 and gravity vector 80 in this case corresponding to the X2 direction. More specifically, loudspeaker SP1 on the left middle of Electronic-Acoustic Device 500 provides the sound output corresponding to the input signal from channel CH11; loudspeaker SP2 on the upper middle of Electronic-Acoustic Device 500 provides the sound output corresponding to the combined input signals from channels CH11+CH12; loudspeaker SP3 on the right middle of Electronic-Acoustic Device 500 provides the sound output corresponding to the input signal from channel CH12; loudspeaker SP4 on the bottom middle of Electronic-Acoustic Device 500 provides the sound output corresponding to the combined input signals from channel CH11+CH12; all of the aforementioned being under the joint control of automatic orientation detector/sensor 580 and channel distributor/director 590. This loudspeaker output operating configuration provides: a left channel; a center or middle channel; and a right channel stereo configuration with expanded channel separation in the primary landscape orientation L1.

FIG. F6 is front view of Electronic-Acoustic Device 500 according the present invention showing: loudspeakers SP1, SP2, SP3, SP4; loudspeaker holding or securing means 91, 93, 95, 97; and the front of housing 550.

FIG. F7 is rear view of Electronic-Acoustic Device 500 according the present invention showing: loudspeakers SP1, SP2, SP3, SP4; loudspeaker holding or securing means 91, 93, 95, 97; and the rear of housing 550.

FIG. F8 is right side view of Electronic-Acoustic Device 500 according the present invention showing: loudspeakers SP1, SP2, SP3; loudspeaker holding or securing means 91, 93, 95; and the right side of housing 550.

FIG. F9 is left side view of Electronic-Acoustic Device 500 according the present invention showing: loudspeakers SP1, SP3, SP4; loudspeaker holding or securing means 91, 95, 97; and the left side of housing 550.

FIG. F10 is top view of Electronic-Acoustic Device 500 according the present invention showing: loudspeakers SP1, SP2, SP4; loudspeaker holding or securing means 91, 93, 97; and the top of housing 550.

FIG. F11 is bottom view of Electronic-Acoustic Device 500 according the present invention showing: loudspeakers SP2, SP3, SP4; loudspeaker holding or securing means 93, 95, 97; and the bottom of housing 550.

FIG. F12 is front view of Electronic-Acoustic Device 500 according the present invention showing: loudspeakers SP1, SP2, SP3, SP4; loudspeaker holding or securing means 91, 93, 95, 97; housing 550; and Attached Electronic Device 800 comprising screen monitor 810. Attached Electronic Device 800 may provide signals to signal source 650 for processing by channel distributor/director 590.

FIG. F13 is rear view of Electronic-Acoustic Device 500 according the present invention showing: loudspeakers SP1, SP2, SP3, SP4; loudspeaker holding or securing means 91, 93, 95, 97; the rear of housing 550. Attached Electronic Device 800 is not visible in this view.

FIG. F14 is right side view of Electronic-Acoustic Device 500 according the present invention showing: loudspeakers SP1, SP2, SP3; loudspeaker holding or securing means 91, 93, 95; the right side of housing 550; and the right side of Attached Electronic Device 800.

FIG. F15 is left side view of Electronic-Acoustic Device 500 according the present invention showing: loudspeakers SP1, SP3, SP4; loudspeaker holding or securing means 91, 95, 97; the left side of housing 550; and the left side of Attached Electronic Device 800.

FIG. F16 is top view of Electronic-Acoustic Device 500 according the present invention showing: loudspeakers SP1, SP2, SP4; loudspeaker holding or securing means 91, 93, 97; the top of housing 550; and the top of Attached Electronic Device 800.

FIG. F17 is bottom view of Electronic-Acoustic Device 500 according the present invention showing: loudspeakers SP2, SP3, SP4; loudspeaker holding or securing means 93, 95, 97; the bottom of housing 550; and the bottom of Attached Electronic Device 800.

While the present invention has been described in terms of specific illustrative embodiments, it will be apparent to those skilled in the art that many other embodiments and modifications are possible within the spirit and scope of the disclosed principle.

What is claimed is:

1) An electronic-acoustic device being responsive to at least one input signal and comprising: A housing having a front surface; A spatial orientation sensor being located within said housing; A sound channel distributor/director for providing a plurality of output signals, being located within said housing, and being jointly responsive to said at least one input signal and to said spatial orientation sensor; A multi-channel amplifier being located within said housing and being responsive to said plurality of output signals of said sound channel distributor/director; And a loudspeaker array being attached to said housing on a plane at or in front of said housing front surface and being responsive to said multi-channel amplifier for producing a plurality of output sounds.

2) In the electronic-acoustic device of claim 1: said spatial orientation sensor detecting a first spatial orientation; and detecting a second spatial orientation being 90 degrees from said first spatial orientation.

3) In the electronic-acoustic device of claim 1: said spatial orientation sensor detecting a first spatial orientation; and detecting a second spatial orientation being 180 degrees from said first spatial orientation.

4) In the electronic-acoustic device of claim 1: wherein said spatial orientation sensor is an inclinometer.

5) In the electronic-acoustic device of claim 1: wherein said spatial orientation sensor is a gravitational accelerometer.

6) In the electronic-acoustic device of claim 1: wherein said multi-channel amplifier is responsive to a first combination of said plurality of output signals from said sound channel distributor/director when said housing is in a first spatial orientation; and wherein said multi-channel amplifier is responsive to a second combination of said plurality of output signals from said sound channel distributor when said housing is in a second spatial orientation.

7) In the electronic-acoustic device of claim 1: wherein said loudspeaker array produces a first set of output sounds in response to said multi-channel amplifier when said housing is in a first spatial orientation; and wherein said loudspeaker array produces a second set of output sounds in response to said multi-channel amplifier when said housing is in a second spatial orientation.

8) In the electronic-acoustic device of claim 1: wherein said loudspeaker array comprises at least four loudspeakers; wherein said housing comprises a top left corner, a top right corner, a bottom right corner, and a bottom left corner; wherein the first of said loudspeakers is located at or in front of said top left corner; wherein the second of said loudspeakers is located at or in front of said top right corner; wherein the third of said loudspeakers is located at or in front of said bottom right corner; and wherein the fourth of said loudspeakers is located at or in front of said bottom left corner.

9) In the electronic-acoustic device of claim 1: wherein said loudspeaker array comprises at least four loudspeakers; wherein said housing comprises a top left corner, a top right corner, a bottom right corner, and a bottom left corner; wherein the first of said loudspeakers is attached to said top left corner by first attachment means; wherein the second of said loudspeakers is attached to said top right corner by second attachment means; wherein the third of said loudspeakers is attached to said bottom right corner by third attachment means; and wherein the fourth of said loudspeakers is attached to said bottom left corner by fourth attachment means.

10) In the electronic-acoustic device of claim 1: wherein said loudspeaker array comprises at least four loudspeakers; wherein said housing comprises a top left corner, a top right corner, a bottom right corner, and a bottom left corner; wherein the first of said loudspeakers is attached to said top left corner by first attachment means; wherein the second of said loudspeakers is attached to said top right corner by second attachment means; wherein the third of said loudspeakers is attached to said bottom right corner by third attachment means; wherein the fourth of said loudspeakers is attached to said bottom left corner by fourth attachment means; and wherein a second electronic device which produces said at least one input signal is securely attached to said electronic-acoustic device utilizing said first, second, third and fourth attachment means.

11) In the electronic-acoustic device of claim 1: wherein said loudspeaker array comprises at least four loudspeakers; wherein said housing comprises a top left corner, a top right corner, a bottom right corner, and a bottom left corner; wherein the first of said loudspeakers is attached to said top left corner by first attachment means; wherein the second of said loudspeakers is attached to said top right corner by second attachment means; wherein the third of said loudspeakers is attached to said bottom right corner by third attachment means; wherein the fourth of said loudspeakers is attached to said bottom left corner by fourth attachment means; wherein a second electronic device which produces said at least one input signal is securely attached to said electronic-acoustic device utilizing said first, second, third and fourth attachment means; and wherein said second electronic device comprises a screen monitor.

12) In the electronic-acoustic device of claim 1: wherein said loudspeaker array comprises at least four loudspeakers; wherein said housing comprises a top left corner, a top right corner, a bottom right corner, and a bottom left corner; wherein the first of said loudspeakers is attached to said top left corner by first attachment means; wherein the second of said loudspeakers is attached to said top right corner by second attachment means; wherein the third of said loudspeakers is attached to said bottom right corner by third attachment means; wherein the fourth of said loudspeakers is attached to said bottom left corner by fourth attachment means; wherein a second electronic device which produces said at least one input signal is securely attached to said electronic-acoustic device utilizing said first, second, third and fourth attachment means; and wherein said second electronic device comprises a cell phone, a smart phone, an iphone, an ipod, or any other similar device.

13) In the electronic-acoustic device of claim 1: wherein said loudspeaker array comprises at least four loudspeakers; wherein said housing comprises a top surface, a right surface, a bottom surface, and a left surface; wherein the first of said loudspeakers is located at or in front of the middle of said top surface; wherein the second of said loudspeakers is located at or in front of the middle of said right surface; wherein the third of said loudspeakers is located at or in front of the middle of said bottom surface; and wherein the fourth of said loudspeakers is located at or in front of the middle of said left surface.

14) In the electronic-acoustic device of claim 1: wherein said loudspeaker array comprises at least four loudspeakers; wherein said housing comprises a top surface, a right surface, a bottom surface, and a left surface; wherein the first of said loudspeakers is attached to the middle of said top surface by first attachment means; wherein the second of said loudspeakers is attached to the middle of said right surface by second attachment means; wherein the third of said loudspeakers is attached to the middle of said bottom surface by third attachment means; and wherein the fourth of said loudspeakers is attached to the middle of said left surface by fourth attachment means.

15) In the electronic-acoustic device of claim 1: wherein said loudspeaker array comprises at least four loudspeakers; wherein said housing comprises a top surface, a right surface, a bottom surface, and a left surface; wherein the first of said loudspeakers is attached to the middle of said top surface by first attachment means; wherein the second of said loudspeakers is attached to the middle of said right surface by second attachment means; wherein the third of said loudspeakers is attached to the middle of said bottom surface by third attachment means; wherein the fourth of said loudspeakers is attached to the middle of said left surface by fourth attachment means; and wherein a second electronic device which produces said at least one input signal is securely attached to said electronic-acoustic device utilizing said first, second, third and fourth attachment means.

16) In the electronic-acoustic device of claim 1: wherein said loudspeaker array comprises at least four loudspeakers; wherein said housing comprises a top surface, a right surface, a bottom surface, and a left surface; wherein the first of said loudspeakers is attached to the middle of said top surface by first attachment means; wherein the second of said loudspeakers is attached to the middle of said right surface by second attachment means; wherein the third of said loudspeakers is attached to the middle of said bottom surface by third attachment means; wherein the fourth of said loudspeakers is attached to the middle of said left surface by fourth attachment means; wherein a second electronic device which produces said at least one input signal is securely attached to said electronic-acoustic device utilizing said first, second, third and fourth attachment means; and wherein said second electronic device comprises a screen monitor.

17) In the electronic-acoustic device of claim 1: wherein said loudspeaker array comprises at least four loudspeakers; wherein said housing comprises a top surface, a right surface, a bottom surface, and a left surface; wherein the first of said loudspeakers is attached to the middle of said top surface by first attachment means; wherein the second of said loudspeakers is attached to the middle of said right surface by second attachment means; wherein the third of said loudspeakers is attached to the middle of said bottom surface by third attachment means; wherein the fourth of said loudspeakers is attached to the middle of said left surface by fourth attachment means; wherein a second electronic device which produces said at least one input signal is securely attached to said electronic-acoustic device utilizing said first, second, third and fourth attachment means; and wherein said second electronic device comprises a cell phone, a smart phone, an iphone, an ipod, or any other similar device.

18) An electronic-acoustic device being responsive to at least one input signal and comprising: A spatial orientation sensor; A sound channel distributor/director for providing a plurality of output signals, and being jointly responsive to said at least one input signal and to said spatial orientation sensor; A multi-channel amplifier being responsive to said plurality of output signals of said sound channel distributor/director; And a loudspeaker array being responsive to said multi-channel amplifier for producing a plurality of output sounds.

19) An electronic-acoustic device being responsive to at least one input signal and comprising: A spatial orientation sensor being responsive to the effect of gravity; A sound channel distributor/director for providing a plurality of output signals, and being jointly responsive to said at least one input signal and to said spatial orientation sensor; A multi-channel amplifier being responsive to said plurality of output signals of said sound channel distributor/director; And a loudspeaker array being responsive to said multi-channel amplifier for producing a plurality of output sounds.
